(19) United States
(12) Patent Application Publication
(10) Pub. No.: US 2026/0244319 A1
(43) Pub. Date: Aug. 20, 2026

(54) ELECTRONIC DEVICE AND METHOD FOR PROVIDING USER INTERFACE

(71) Applicant: Samsung Electronics Co., Ltd., Suwon-si (KR)

(72) Inventors: Jiwoo HONG, Suwon-si (KR); Youngchan WOO, Suwon-si (KR); Donghee KANG, Suwon-si (KR)

(21) Appl. No.: 19/641,129

(22) Filed: Apr. 7, 2026

Related U.S. Application Data
(63) Continuation of application No. PCT/KR2024/012890, filed on Aug. 28, 2024.

(30) Foreign Application Priority Data
Oct. 12, 2023 (KR) 10-2023-0136001

(51) Int. Cl. G06F 3/0484; G06F 3/01; G06F 3/04815; G06F 9/451; G06T 7/20

(52) U.S. Cl. CPC G06F 3/0484; G06F 3/013; G06F 3/04815; G06F 9/451; G06T 7/20; G06T 2200/24; G06T 2207/30196; G06T 2207/30241

(57) ABSTRACT

A method for providing a user interface (UI) by a first electronic device is provided. The method includes receiving, from a second electronic device, first application information associated with a first application executed on the second electronic device, in response to receiving the first application information, identifying first user interface (UI) information associated with the first application information from among stored UI information, and based on the first UI information, displaying at least one first UI for controlling the first application in a specified spatial area, wherein the specified spatial area includes a spatial area set by a user within a real environment image obtained in real time by the first electronic device.

### CROSS-REFERENCE TO RELATED APPLICATION(S)

This application is a continuation application, claiming priority under 35 U.S.C. § 365(c), of an International application No. PCT/KR2024/012890, filed on August 28, 2024, which is based on and claims the benefit of a Korean patent application number 10-2023-0136001, filed on October 12, 2023, in the Korean Intellectual Property Office (KIPO), the disclosure of which is incorporated by reference herein in its entirety.

### BACKGROUND

### 1. Field

The disclosure relates to an electronic device and a method for providing a user interface.

### 2. Description of Related Art

Extended reality (XR) technology is an immersive technology connecting the real world and the virtual world, and may have a meaning encompassing virtual reality (VR) technology, mixed reality (MR) technology, or augmented reality (AR) technology. VR technology may refer to technology that draws a user into a virtual reality distinguished from actual reality. AR technology may refer to technology that provides an extended visual experience to a user by adding virtual images or information to actual reality. MR technology may refer to technology that combines actual reality and virtual reality so that virtual objects are integrated into actual reality and interact.

XR technology may be used based on various electronic devices, such as a smartphone, a tablet, an XR headset, video see-through (VST), or a head-mounted display (HMD). XR technology may be utilized in various fields, such as gaming, education, entertainment, military training, medical simulation, and architecture and manufacturing, and may provide new experiences to a user by fusing the real world and the virtual world.

The above information is presented as background information only to assist with an understanding of the disclosure. No determination has been made, and no assertion is made, as to whether any of the above might be applicable as prior art with regard to the disclosure.

### SUMMARY

A first electronic device utilizing XR technology provides a display function enabling a user to view a virtual world and an interaction function based on a separate controller or a gesture of the user. However, the existing interaction function has a limitation in that it is difficult to support tasks of creating documents, videos, or music that have been performed on an input/output device (e.g., a personal computer (PC) or a laptop).

The first electronic device has storage and control capabilities, but has no choice but to perform input/output operations based on the storage and control capabilities of a second electronic device (e.g., a computing device or a server) linked with the first electronic device. In other words, in the related art, there is a problem in that the input/output operation of the first electronic device is dependent on the storage and control capabilities of the second electronic device.

In case that the first electronic device performs an input/output operation in conjunction with the second electronic device, the first electronic device augments virtual information on an input device of the second electronic device, e.g., an existing input device, such as a keyboard, to guide a physical key input to the user or provide a new key input function. However, a position where the virtual information is augmented and displayed is not determined differently for each user and thus does not have a personalized form, and the use of a new key input function conflicts with the use of the existing input device, which rather reduces usability associated with input.

Therefore, in an environment where the first electronic device and the second electronic device are linked, there is a demand for provision of an input interface that does not conflict with the use of the existing input device, is personalized, and has increased usability.

Aspects of the disclosure are to address at least the above-mentioned problems and/or disadvantages and to provide at least the advantages described below. Accordingly, an aspect of the disclosure is to provide an electronic device and a method for providing a user interface (UI).

Another aspect of the disclosure is to provide an electronic device and a method for providing a personalized input interface for each user.

Another aspect of the disclosure is to provide a device and a method for generating various UIs based on a preference of a user by allowing the user to set various information associated with a UI (e.g., UI control information, a UI display method, or a UI display position).

Another aspect of the disclosure is to provide a device and a method for controlling an application running on a second electronic device (e.g., an input/output device, such as a laptop) or providing a large-capacity object, based on information stored in a first electronic device (e.g., an XR device).

Another aspect of the disclosure is to provide a device and a method for enabling the first electronic device to efficiently perform an input to the second electronic device through a simple method, such as a spatial touch by augmenting and displaying a virtual UI at a position set by the user.

Additional aspects will be set forth in part in the description which follows and, in part, will be apparent from the description, or may be learned by practice of the presented embodiments.

In accordance with an aspect of the disclosure, a first electronic device is provided. The first electronic device includes a sensor, a display, a transceiver, memory, including one or more storage media, storing instructions, and at least one processor communicatively coupledto the sensor, the display, the transceiver, and the memory, wherein the instructions, when executed by the at least one processor individually or collectively, cause the first electronic device to receive, from a second electronic device, first application information associated with a first application executed on the second electronic device, in response to receiving the first application information, identify first user interface (UI) information associated with the first application information among UI information stored in the memory, and based on the first UI information, control the display to display at least one first UI for controlling the first application in a specified spatial area, wherein the specified spatial area includes a spatial area set by a user within a real environment image obtained in real-time by the sensor.

According to an embodiment of the disclosure, the at least one processor is configured to control the display to display a first screen associated with the first application based on screen information included in the first application information, determine whether any one of the at least one first UI has been selected by the user, based on any one of the at least one first UI being selected by the user, control the transceiver to transmit control information corresponding to the selected UI to the second electronic device, in response to transmitting the control information, receive updated screen information from the second electronic device through the transceiver, and based on receiving the updated screen information, control the display to change the first screen to a second screen corresponding to the updated screen information.

According to an embodiment of the disclosure, the at least one first UI is generated based on user setting information provided from the second electronic device, and the user setting information includes information indicating at least one control command selected by the user among one or more control commands for controlling the first application, and information indicating at least one of a name, an icon, a color, a font, or a visual effect set by the user corresponding to the at least one first UI.

According to an embodiment of the disclosure, the sensor is further configured to detect a gaze of the user, and the at least one processor is configured to identify a UI corresponding to the gaze of the user among the at least one first UI, and control the display to display a preview image associated with the identified UI.

According to an embodiment of the disclosure, the at least one processor is configured to identify a drawing trajectory generated by the user in a real environment image obtained in real-time by the sensor, and determine an area corresponding to the identified drawing trajectory as a spatial area set by the user.

According to an embodiment of the disclosure, the at least one processor is configured to determine whether the at least one first UI is displayed overlapping at least one object within the real environment image, and based on the at least one first UI being displayed overlapping the at least one object, control the display to relocate and display the at least one first UI at a position not overlapping the at least one object.

According to an embodiment of the disclosure, the at least one processor is configured to identify a UI selected by the user among the at least one first UI, based on the selected UI being associated with a large-capacity object having a capacity equal to or greater than a set capacity, obtain the large-capacity object stored in the memory, and control the display to display a screen based on the obtained large-capacity object, and the large-capacity object includes at least one of an image, audio, or video provided from the second electronic device.

According to an embodiment of the disclosure, the at least one processor is configured to receive, from the second electronic device, second application information associated with a plurality of second applications executed on the second electronic device, in response to receiving the second application information, identify second UI information associated with the second application information among the stored UI information, and control the display to display at least one second UI in the specified spatial area based on the second UI information, and the at least one second UI includes at least one of at least one UI for controlling functions provided by each of the plurality of second applications at once, or a plurality of UIs for separately controlling functions provided by each of the plurality of second applications.

According to an embodiment of the disclosure, the at least one processor is configured to identify that at least one third UI associated with a third application executed on the second electronic device is displayed on a third electronic device linked with the second electronic device, based on the at least one third UI being displayed on the third electronic device, identify third UI information associated with the at least one third UI among the stored UI information, and control the display to display at least one fourth UI in the specified spatial area based on the third UI information, and the at least one fourth UI includes at least one UI for changing at least one of a size, a color, an icon, a font, or a visual effect of the at least one third UI displayed on the third electronic device.

According to an embodiment of the disclosure, the at least one first UI includes at least one UI for controlling at least one function provided by the first application using an input device of a fourth electronic device linked with the first electronic device.

In accordance with another aspect of the disclosure, a method for providing a user interface (UI) by a first electronic device is provided. The method includes receiving, by the first electronic device from a second electronic device, first application information associated with a first application executed on the second electronic device, in response to receiving the first application information, identifying, by the first electronic device, first UI information associated with the first application information among stored UI information, and based on the first UI information, displaying, by the first electronic device, at least one first UI for controlling the first application in a specified spatial area, wherein the specified spatial area includes a spatial area set by a user within a real environment image obtained in real-time by the first electronic device.

According to an embodiment of the disclosure, the method further includes displaying a first screen associated with the first application based on screen information included in the first application information, determining whether any one of the at least one first UI has been selected by the user, based on any one of the at least one first UI being selected by the user, transmitting control information corresponding to the selected UI to the second electronic device, in response to transmitting the control information, receiving updated screen information from the second electronic device, and based on receiving the updated screen information, changing the first screen to a second screen corresponding to the updated screen information.

According to an embodiment of the disclosure, the at least one first UI is generated based on user setting information provided from the second electronic device, and the user setting information includes information indicating at least one control command selected by the user among one or more control commands for controlling the first application, and information indicating at least one of a name, an icon, a color, a font, or a visual effect set by the user corresponding to the at least one first UI.

According to an embodiment of the disclosure, the method further includes identifying a UI corresponding to a gaze of the user among the at least one first UI, and displaying a preview image associated with the identified UI.

According to an embodiment of the disclosure, the method further includes identifying a drawing trajectory generated by the user in the real environment image obtained in real-time, and determining an area corresponding to the identified drawing trajectory as a spatial area set by the user.

According to an embodiment of the disclosure, the method further includes determining whether the at least one first UI is displayed overlapping at least one object within the real environment image, and based on the at least one first UI being displayed overlapping the at least one object, relocating and displaying the at least one first UI at a position not overlapping the at least one object.

According to an embodiment of the disclosure, the method further includes identifying a UI selected by the user among the at least one first UI, based on the selected UI being associated with a large-capacity object having a capacity equal to or greater than a set capacity, obtaining the large-capacity object stored, and displaying a screen based on the obtained large-capacity object, and the large-capacity object includes at least one of an image, audio, or video provided from the second electronic device.

According to an embodiment of the disclosure, the method further includes receiving, from the second electronic device, second application information associated with a plurality of second applications executed on the second electronic device, in response to receiving the second application information, identifying second UI information associated with the second application information among the stored UI information, and controlling the display to display at least one second UI in the specified spatial area based on the second UI information, and the at least one second UI includes at least one of at least one UI for controlling functions provided by each of the plurality of second applications at once, or a plurality of UIs for respectively controlling functions provided by each of the plurality of second applications.

According to an embodiment of the disclosure, the method further includes identifying that at least one third UI associated with a third application executed on the second electronic device is displayed on a third electronic device linked with the second electronic device, based on the at least one third UI being displayed on the third electronic device, identifying third UI information associated with the at least one third UI among the stored UI information, and displaying at least one fourth UI in the specified spatial area based on the third UI information, and the at least one fourth UI includes at least one UI for changing at least one of a size, a color, an icon, a font, or a visual effect of the at least one third UI displayed on the third electronic device.

According to an embodiment of the disclosure, the at least one first UI includes at least one UI for controlling at least one function provided by the first application using an input device of a fourth electronic device linked with the first electronic device.

In accordance with another aspect of the disclosure, one or more non-transitory computer-readable storage media storing one or more computer programs including computer-executable instructions that, when executed by one or more processors of a first electronic device individually or collectively, cause the first electronic device to perform operations are provided. The operations include receiving, by the first electronic device from a second electronic device, first application information associated with a first application executed on the second electronic device, in response to receiving the first application information, identifying, by the first electronic device, first user interface (UI) information associated with the first application information among stored UI information, and based on the first UI information, displaying, by the first electronic device, at least one first UI for controlling the first application in a specified spatial area, wherein the specified spatial area includes a spatial area set by a user within a real environment image obtained in real-time by the first electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a first electronic device and a second electronic device according to an embodiment of the disclosure;

FIG. 2A is a view illustrating an operation of setting a key area in a first electronic device according to an embodiment of the disclosure;

FIG. 2B is a view illustrating an operation of setting key information in a second electronic device according to an embodiment of the disclosure;

FIG. 2C is a view illustrating a screen on which a first key is displayed in a first electronic device according to an embodiment of the disclosure;

FIG. 3A is a view illustrating an operation of setting key information in a second electronic device according to an embodiment of the disclosure;

FIG. 3B is a view illustrating a screen on which a second key is displayed in a first electronic device according to an embodiment of the disclosure;

FIG. 4 is a flowchart illustrating operations of a first electronic device and a second electronic device for generating a key associated with an application according to an embodiment of the disclosure;

FIG. 5 is a flowchart illustrating operations of a first electronic device and a second electronic device for a key input associated with an application according to an embodiment of the disclosure;

FIG. 6A is a view illustrating execution screens of a plurality of applications for generating an integrated key according to an embodiment of the disclosure;

FIG. 6B is a view illustrating a screen on which a task based on a plurality of applications is performed using an integrated key according to an embodiment of the disclosure;

FIG. 7A is a view illustrating a screen on which a plurality of keys for a third electronic device linked with a second electronic device are generated according to an embodiment of the disclosure;

FIG. 7B is a view illustrating a screen on which a design of a television (TV) key displayed on a third electronic device is controlled based on a plurality of keys according to an embodiment of the disclosure;

FIG. 8A is a view illustrating a change in a surrounding environment of a second electronic device according to an embodiment of the disclosure;

FIG. 8B is a view illustrating a screen on which an automatic key arrangement function is executed in a first electronic device based on a change in a surrounding environment of a second electronic device according to an embodiment of the disclosure;

FIG. 9A is a view illustrating a screen on which a first electronic device displays a key corresponding to each of a plurality of applications according to an embodiment of the disclosure;

FIG. 9B is a view illustrating a screen on which a first electronic device merges and displays keys corresponding to each of a plurality of applications according to an embodiment of the disclosure;

FIG. 10A is a view illustrating a screen on which a first electronic device identifies a key associated with a selected menu of an application according to an embodiment of the disclosure;

FIG. 10B is a view illustrating a screen on which a first electronic device visually emphasizes and displays a key associated with a selected menu of an application according to an embodiment of the disclosure;

FIG. 11 is a view illustrating a screen on which a first electronic device provides a large-capacity object according to an embodiment of the disclosure;

FIG. 12A is a view illustrating a screen on which an application is used based on a fourth electronic device linked with a first electronic device according to an embodiment of the disclosure;

FIG. 12B is a view illustrating a screen on which a key associated with an electronic pen is generated in a first electronic device according to an embodiment of the disclosure;

FIG. 12C is a view illustrating a screen on which a key associated with an electronic pen is used in a first electronic device according to an embodiment of the disclosure;

FIG. 13 is a flowchart illustrating an operation of a first electronic device displaying at least one UI associated with a first application according to an embodiment of the disclosure;

FIG. 14 is a flowchart illustrating an operation of a first electronic device controlling a first application based on a UI selected by the user according to an embodiment of the disclosure;

FIG. 15 is a flowchart illustrating an operation of a first electronic device displaying a preview image associated with a UI according to an embodiment of the disclosure;

FIG. 16 is a flowchart illustrating an operation of a first electronic device generating a spatial area for displaying a UI according to an embodiment of the disclosure;

FIG. 17 is a flowchart illustrating a UI relocation operation of a first electronic device according to an embodiment of the disclosure;

FIG. 18 is a flowchart illustrating an operation of a first electronic device displaying a large-capacity object according to an embodiment of the disclosure;

FIG. 19 is a flowchart illustrating an operation of a first electronic device displaying a UI associated with a plurality of applications according to an embodiment of the disclosure;

FIG. 20 is a flowchart illustrating an operation of a first electronic device changing a design of a UI displayed on a third electronic device according to an embodiment of the disclosure;

FIG. 21 is a block configuration diagram illustrating a first electronic device according to an embodiment of the disclosure; and

FIG. 22 is a block configuration diagram illustrating a second electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

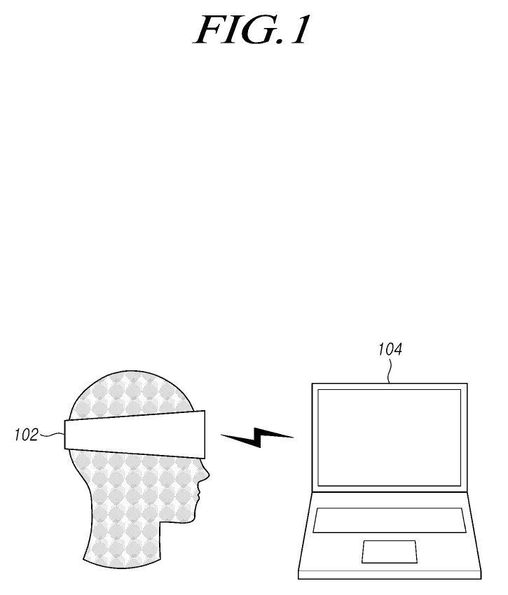

FIG. 1 is a view illustrating a first electronic device and a second electronic device according to an embodiment of the disclosure.

Referring to FIG. 1, a first electronic device 102 is a device supporting extended reality (XR) technology, and may provide a service based on at least one of virtual reality (VR) technology, mixed reality (MR) technology, or augmented reality (AR) technology to a user. As illustrated in FIG. 1, the first electronic device 102 may be video see-through (VST), but the disclosure is not limited thereto. For example, the first electronic device 102 may be an electronic device different from VST (e.g., a smartphone, a tablet, an XR headset, or a head-mounted display (HMD)).

A second electronic device 104 may be a device capable of performing an input/output function (or an input function and a display function) and executing one or more applications. As illustrated in FIG. 1, the second electronic device 104 may be a laptop, but the disclosure is not limited thereto. For example, the second electronic device 104 may be an electronic device different from a laptop (e.g., a PC, a tablet, or a smartphone).

The first electronic device 102 and the second electronic device 104 may be connected and perform wired and/or wireless communication. For example, the first electronic device 102 may perform wired communication with the second electronic device 104 using at least one cable, or may perform wireless communication with the second electronic device 104 based on at least one of various wireless communication technologies (e.g., wireless fidelity (Wi-Fi), Bluetooth, long term evolution (LTE), LTE advance (LTE-A), or new radio (NR) communication technology).

According to an example, the first electronic device 102 may receive information on a first application executed on the second electronic device 104, and display a screen associated with the first application based on the received information. According to an example, the first electronic device 102 may generate at least one first user interface (UI) for controlling the first application.

According to an example, the at least one first UI may include at least one key displayed on the first electronic device 102. The at least one key may be an augmented reality image displayed as a virtual object in a real environment image, and may be referred to as a virtual key, a virtual shortcut key, a virtual hotkey, a hotkey, or a virtual keyboard. The at least one key may be displayed in a key area that is a spatial area or a UI area set by the user, and may be used as a spatial input interface.

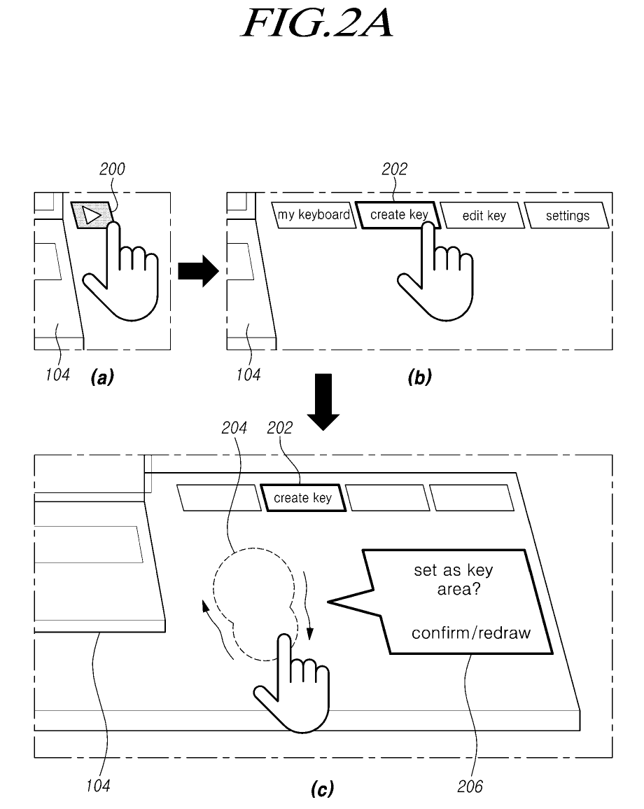

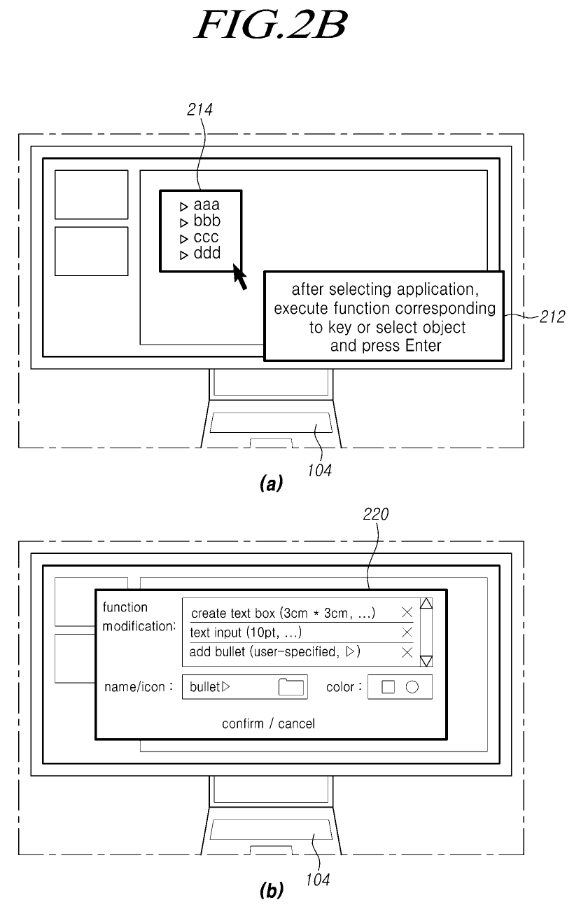

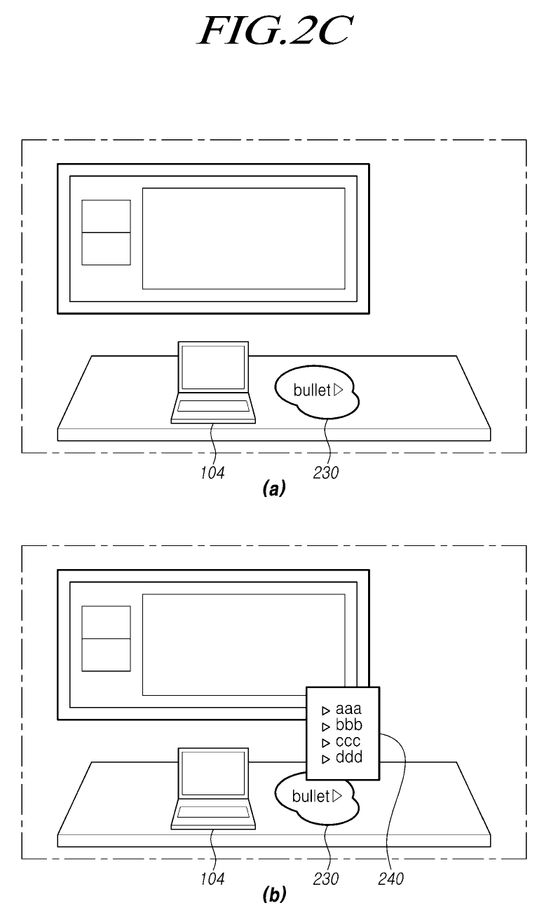

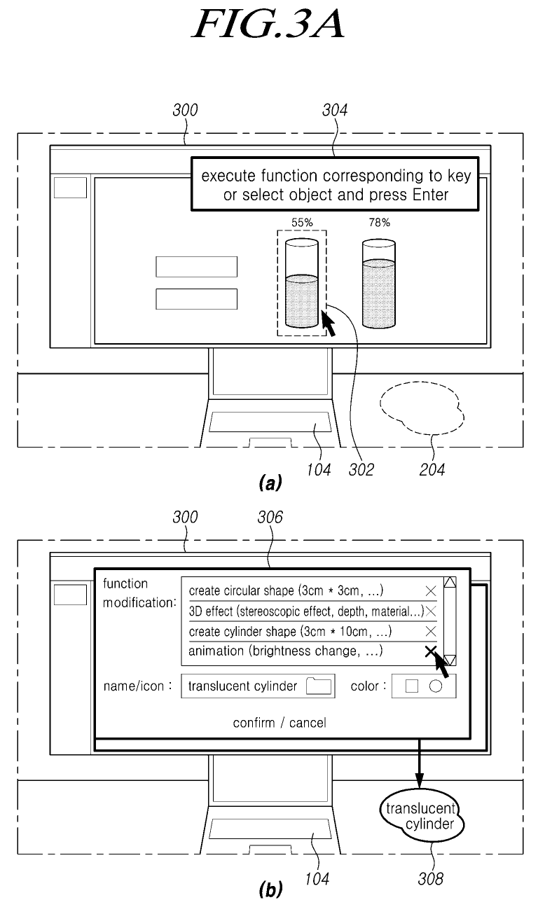

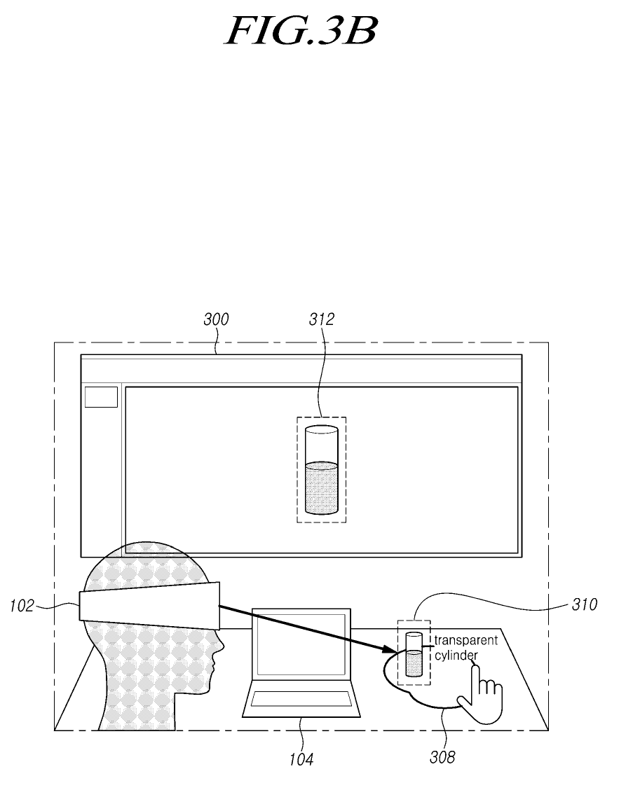

Hereinafter, an operation of generating a key by the first electronic device 102 is described with reference to FIGS. 2A, 2B, 2C, 3A and 3B.

FIG. 2A is a view illustrating an operation of setting a key area in a first electronic device according to an embodiment of the disclosure.

Referring to part (a) of FIG. 2A, the first electronic device 102 may additionally display a setting menu 200 for generating a key area in a state in which a real environment image obtained in real-time is displayed. According to an example, the setting menu 200 may be displayed as an augmented graphic menu. The first electronic device 102 may display the setting menu 200 in an area adjacent to the second electronic device 104 (e.g., a right area of the second electronic device 104), or in a position desired by the user. The position desired by the user may be identified based on at least one of a touch of the user, a gesture of the user, or a gaze of the user.

According to an example, the setting menu 200 may be selected by a touch input of the user, and a screen transition from part (a) of FIG. 2A to part (b) of FIG. 2A may be performed based on the selection of the setting menu 200.

Referring to part (b) of FIG. 2A, the first electronic device 102 may display sub menus (e.g., my keyboard, create key, key modification and setting) in response to the setting menu 200 being selected by the user. In case that a create key menu 202 is selected by the user among the sub menus, the first electronic device 102 may determine whether the user has performed drawing in a set form.

According to an example, the drawing in the set form may refer to an operation in which the user draws a two-dimensional or three-dimensional object having a specific form or structure (e.g., a figure having an area, such as a circle, a rectangle, or a cylinder) in space. According to an example, the user may perform the drawing in the set form using a finger. In case that the user has not performed the drawing in the set form (e.g., in case that the user has drawn a straight line or a curved line having no area), the first electronic device 102 may display a message instructing the user to perform the drawing in the set form. According to an example, a space in which the user performs the drawing may not be limited, and may be anywhere in actual space.

Referring to part (c) of FIG. 2A, in case of determining that the user has performed the drawing in the set form, the first electronic device 102 may track a drawing trajectory based on a movement of the finger of the user, and display a spatial area 204 generated by the tracked drawing trajectory. For example, the first electronic device 102 may display the drawing trajectory corresponding to the generated spatial area 204 as a solid line or a dashed line, or fill the generated spatial area 204 with a specific color, so that the user may check the generated spatial area 204.

According to an example, the first electronic device 102 may display a message 206 (e.g., Set as key area? OK/Redraw) for checking whether the user will set the generated spatial area 204 as a key area. For example, the message 206 may be displayed at a position associated with the generated spatial area 204.

In case that the user does not set the generated spatial area 204 as a key area (e.g., in case that a "Redraw" button in the message 206 is selected), the first electronic device 102 may end the display of the generated spatial area 204 so that the drawing in the set form may be re-performed.

In case that the user sets the generated spatial area 204 as a key area (e.g., in case that an "OK" button in the message 206 is selected), the first electronic device 102 may store information on the generated spatial area 204 as key area information associated with the first application and/or the at least one first key. According to an example, the first electronic device 102 may display a message indicating that the generated spatial area 204 has been set as a key area on a screen. Since the key area corresponds to the spatial area 204 set by the user, hereinafter, it may be referred to as "the key area 204."

Based on the key area 204 being set, the user may perform an operation of setting information associated with the key to be displayed in the key area 204, e.g., key information, in the second electronic device 104.

FIG. 2B is a view illustrating an operation of setting key information in a second electronic device according to an embodiment of the disclosure.

According to an example, the second electronic device 104 may execute an information setting plug-in (or a program) for generating a UI (e.g., generating a key) associated with an application, based on a selection of the user. The second electronic device 104 may display an execution screen of the information setting plug-in. For example, the execution screen may be the screen illustrated in part (a) of FIG. 2B.

Referring to part (a) of FIG. 2B, the execution screen may include a guidance message 212 (e.g., Select an application, then execute a function to correspond to a key or select an object, and press Enter) for guiding an operation of the user. In response to the user selecting the first application and executing one or more functions (e.g., aaa, bbb, ccc, ddd 214) associated with the first application based on the guidance message 212, the second electronic device 104 may display a screen as illustrated in part (b) of FIG. 2B.

Part (b) of FIG. 2B is a view illustrating an example of setting control information corresponding to the first key to be displayed in the key area (e.g., the key area 204 illustrated in part (c) of FIG. 2A), which is associated with the first application. According to an example, the second electronic device 104 may display a window 220 for allowing the user to set the control information on the screen. The setting of the control information by the user may be performed based on, e.g., an input device (e.g., a keyboard and/or a mouse) of the second electronic device 104.

According to an example, the second electronic device 104 may display one or more control commands associated with the one or more functions (e.g., aaa, bbb, ccc, ddd 214 illustrated in part (a) of FIG. 2B) selected by the user. For example, the second electronic device 104 may display control commands, such as "create text box, input text, and add bullet." The user may select all or some of the control commands displayed on the second electronic device 104 as the control information. For example, the user may select a control command corresponding to a function desired by the user among all the control commands as the control information. According to an example, in case that a UI displayed as "X" corresponding to at least one of the displayed control commands is selected, the second electronic device 104 may exclude the at least one control command corresponding to the selected UI from the control information.

According to an example, in case that at least one of the one or more control commands is a control command requiring a numerical setting, the corresponding numerical value may be set or modified by the user. For example, a size of the text box may be set to "3cm * 3cm" by the user, and a size of text may be modified from a default value of "9pt" to "10pt" set by the user.

According to an example, in case that at least one of the one or more control commands is a function requiring an input or a selection of the user, the input or the selection of the user may be preset. For example, the bullet may be preset to a symbol "▷" designated by the user.

According to an example, at least one of a name, an icon, a color, a font, or a visual effect corresponding to the first key may be set by the user. For example, the name of the first key may be set to "Bullet," the icon of the first key may be set to "Bullet▷," and the color may be set to "yellow."

According to an example, the control information corresponding to the first key and information on at least one of a name, an icon, a color, a font, or a visual effect corresponding to the first key may be set by the user. In case that an input of the user indicating that information setting has been completed is received, the second electronic device 104 may transmit the information set by the user as key information on the first key to the first electronic device 102.

FIG. 2C is a view illustrating a screen on which a first key is displayed in a first electronic device according to an embodiment of the disclosure.

Referring to part (a) of FIG. 2C, the first electronic device 102 may receive the key information on a first key 230 from the second electronic device 104. The first electronic device 102 may store the received key information as information associated with the first application and/or the first key 230. In case that the first application is executed on the second electronic device 104, the first electronic device 102 may receive first application information associated with the first application from the second electronic device 104. The first electronic device 102 may identify the key information associated with the first application based on the first application information.

The first electronic device 102 may display the first key 230 based on the identified key information. According to an example, the first key 230 may be displayed in the specified key area (e.g., the key area 204 illustrated in part (c) of FIG. 2A).

According to an example, the key information used to display the first key 230 may include information on one or more functions of the first application (e.g., aaa, bbb, ccc, ddd 214 illustrated in part (a) of FIG. 2B), control information corresponding to the first key 230 (e.g., create text box (3cm*3cm, ...), input text (10pt, ...), add bullet (user-designated, ▷)), name information of the first key 230 (e.g., Bullet) or icon information (e.g., Bullet▷), or color information of the first key 230 (e.g., yellow).

According to an example, the first electronic device 102 may display the first key 230 in the key area as an icon of "Bullet▷" in yellow, based on the icon information of the first key 230 (e.g., Bullet▷) and the color information of the first key 230 (e.g., yellow).

According to an example, in case that it is detected that the finger of the user is positioned on the first key 230 displayed in the key area or the gaze of the user corresponds thereto, the first electronic device 102 may display a preview image 240 as illustrated in part (b) of FIG. 2C. The preview image 240 may be an image representing information on one or more functions of the application (e.g., ▷aaa, ▷bbb, ▷ccc, ▷ddd) corresponding to the first key 230.

According to an example, in response to the user touching the first key 230, the first electronic device 102 may transmit control information (e.g., create text box (3cm * 3cm, ...), input text (10pt, ...), add bullet (user-designated, ▷)) corresponding to the first key 230 to the second electronic device 104.

According to an example, the second electronic device 104 may control the first application to input the bullets of "▷aaa, ▷bbb, ▷ccc, ▷ddd" in a text box of 3cm * 3cm in text having a size of 10pt, based on the control information received from the first electronic device 102. The second electronic device 104 may transmit screen information reflecting a control result of the first application to the first electronic device 102. The first electronic device 102 may update a screen associated with the first application based on the screen information received from the second electronic device 104.

In FIGS. 2B and 2C, an example of setting the first key 230 for controlling a function of the first application has been described. Hereinafter, an example of setting a second key for controlling an object of a second application is described with reference to FIGS. 3A and 3B. The operation described with reference to FIGS. 3A and 3B may be performed following the key area setting operation described with reference to FIG. 2A.

FIG. 3A is a view illustrating an operation of setting key information in a second electronic device according to an embodiment of the disclosure.

According to an example, the second electronic device 104 may execute the information setting plug-in based on the selection of the user. For example, the information setting plug-in may be executed by the user based on a second application (e.g., a document writing application) 300 being executed on the second electronic device 104 and one or more objects being generated. In case that the information setting plug-in is executed, the second electronic device 104 may display an execution screen as illustrated in part (a) of FIG. 3A.

Referring to part (a) of FIG. 3A, the execution screen may include a guidance message 304 (e.g., Execute a function to correspond to a key or select an object, and press Enter) for guiding an operation of the user. The second electronic device 104 may identify at least one object 302 (e.g., a first cylindrical object) selected by the user based on the guidance message 304. According to an example, the at least one object 302 may include a three-dimensional figure object generated by the user through several command steps using the second application 300.

Part (b) of FIG. 3A is a view illustrating an example of setting control information corresponding to the second key for controlling the second application 300. According to an example, the second electronic device 104 may display a window 306 for allowing the user to set control information corresponding to the second key on the screen. The setting of the control information by the user may be performed based on, e.g., an input device (e.g., a keyboard and/or a mouse) of the second electronic device 104.

According to an example, the second electronic device 104 may display one or more control commands for controlling at least one object (e.g., the first cylindrical object 302 of part (a) of FIG. 3A) selected by the user. For example, the second electronic device 104 may display control commands, such as "create circular figure, threedimensional (3D) effect and create cylindrical figure, animation." The user may select all or some of the control commands displayed on the second electronic device 104 as the control information corresponding to the second key. According to an example, in case that a UI displayed as "X" corresponding to at least one of the displayed control commands is selected, the second electronic device 104 may exclude the at least one control command (e.g., animation) corresponding to the selected UI from the control information.

According to an example, in case that at least one of the one or more control commands is a control command requiring a numerical setting, the corresponding numerical value may be set or modified by the user. For example, the size of the circular figure may be set to "3cm*3cm" by the user, and the size of the cylindrical figure may be set to "3cm*10cm" by the user. For example, in case that a first default value corresponding to the size of the circular figure and a second default value corresponding to the size of the cylindrical figure are set, the first default value and the second default value may be modified to "3cm*3cm" and "3cm*10cm" by the user, respectively.

According to an example, in case that at least one of the one or more control commands is a function requiring an input or a selection of the user, the input or the selection of the user may be preset. For example, information associated with the 3D effect (e.g., stereoscopic effect, depth, material-related information) may be preset by the user.

According to an example, at least one of a name, an icon, a color, a font, or a visual effect corresponding to the second key may be set by the user. For example, the name or icon of the second key may be set to "Translucent cylinder," and the color may be set to "blue."

According to an example, the control information corresponding to the second key and information on at least one of a name, an icon, a color, a font, or a visual effect corresponding to the second key may be set by the user. In case that an input of the user indicating that information setting has been completed is received, the second electronic device 104 may transmit the information set by the user as key information on a second key 308 to the first electronic device 102.

The first electronic device 102 may receive the key information on the second key 308 from the second electronic device 104. The first electronic device 102 may store the received key information as information associated with the second application 300 and/or the second key 308.

In case that the second application 300 is executed on the second electronic device 104, the first electronic device 102 may receive second application information associated with the second application 300 from the second electronic device 104. The first electronic device 102 may identify the key information associated with the second application 300 based on the second application information.

The first electronic device 102 may display the second key 308 based on the identified key information. According to an example, the second key 308 may be displayed in the specified key area (e.g., the key area 204 of part (c) of FIG. 2A or the key area 204 of part (a) of FIG. 3A).

According to an example, the key information used to display the second key 308 may include information on the at least one object of the second application 300 (e.g., the first cylindrical object 302 of part (a) of FIG. 3A) corresponding to the second key 308, control information corresponding to the second key 308 (e.g., create circular figure, 3D effect and create cylindrical figure), name or icon information of the second key 308 (e.g., translucent cylinder), and color information of the second key 308 (e.g., blue).

According to an example, the first electronic device 102 may display the second key 308 in the key area as text of "translucent cylinder" in blue, based on the name or icon information of the second key 308 (e.g., translucent cylinder) and the color information of the second key 308 (e.g., blue).

FIG. 3B is a view illustrating a screen on which a second key is displayed in a first electronic device according to an embodiment of the disclosure.

Referring to FIG. 3B, in case that the second application 300 is executed on the second electronic device 104, the first electronic device 102 may display the second key 308. In case that it is detected that the finger of the user is positioned on the second key 308 displayed in the key area or the gaze of the user corresponds thereto, the first electronic device 102 may display a preview image 310 as illustrated in FIG. 3B. The preview image 310 may include an image (e.g., translucent cylinder) associated with the at least one object 312 of the second application 300 corresponding to the second key 308.

According to an example, in response to the user touching the second key 308, the first electronic device 102 may transmit control information (e.g., create circular FIGURE(3cm*3cm), 3D effect (stereoscopic effect, depth, material) and create cylindrical FIGURE(3cm*10cm)) corresponding to the second key 308 to the second electronic device 104.

According to an example, the second electronic device 104 may control the second application 300 to generate a three-dimensional translucent cylinder including a circular figure of 3cm*3cm and a cylindrical figure of 3cm*10cm, based on the control information received from the first electronic device 102. The second electronic device 104 may transmit screen information reflecting a control result of the second application 300 to the first electronic device 102. The first electronic device 102 may update a screen associated with the second application based on the screen information received from the second electronic device 104.

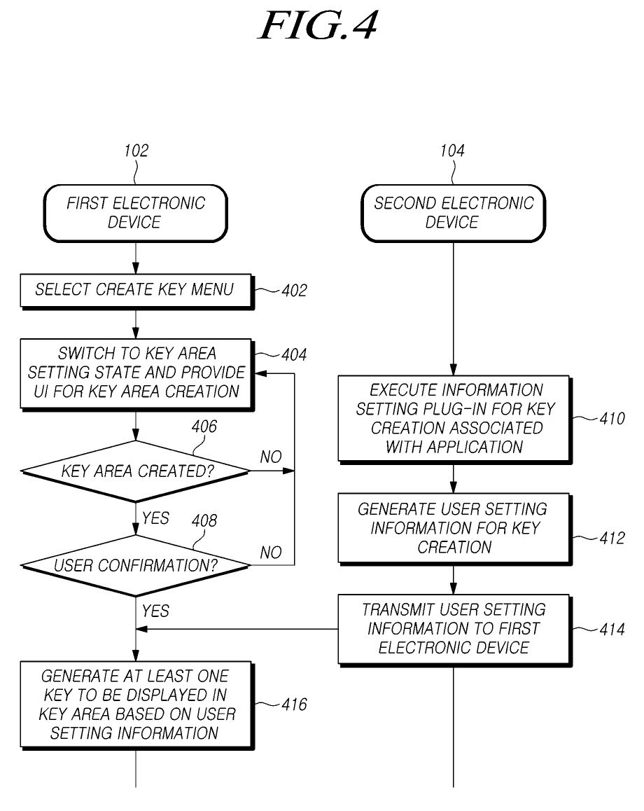

FIG. 4 is a flowchart illustrating operations of a first electronic device and a second electronic device for generating a key associated with an application according to an embodiment of the disclosure.

Referring to FIG. 4, in operation 402, the first electronic device 102 may identify that the user has selected the create key menu (e.g., the create key menu 202 illustrated in part (b) of FIG. 2A). According to an example, the selection of the create key menu by the user may be associated with the operations of parts (a) and (b) of FIG. 2A.

In operation 404, in response to the user selecting the create key menu, the first electronic device 102 may transition to a key area setting state and provide a UI for generating a key area.

In operation 406, the first electronic device 102 may determine whether the user has generated a key area based on the UI for generating the key area. For example, the first electronic device 102 may determine whether the user has performed the drawing in the set form and generated a key area based on the performed drawing. The first electronic device 102 may re-perform operation 404 in case that the user has not generated the key area, and may perform operation 408 in case that the user has generated the key area.

In operation 408, the first electronic device 102 may determine whether there is user identification for the generated key area. The first electronic device 102 may re-perform operation 404 in case that it is identified that the user will not use the generated key area, and may perform operation 416 in case that it is identified that the user will use the generated key area.

In operation 410, the second electronic device 104 may execute the information setting plug-in for generating a key associated with an application.

In operation 412, the second electronic device 104 may generate user setting information for generating a key based on the executed information setting plug-in. The user setting information may refer to key information corresponding to at least one key. The user setting information may include, e.g., control information indicating at least one control command selected by the user among one or more control commands for controlling the application, and information indicating at least one of a name, an icon, a color, a font, or a visual effect set by the user corresponding to the at least one key.

In operation 414, the second electronic device 104 may transmit the user setting information to the first electronic device.

In operation 416, the first electronic device 102 may receive the user setting information from the second electronic device 104, and generate at least one key (e.g., the first key 230 of FIG. 2C or the second key 308 of FIG. 3A) to be displayed in the key area based on the received user setting information. The at least one key may indicate the at least one control command selected by the user, and may be displayed based on at least one of a name, an icon, a color, a font, or a visual effect set by the user. According to an example, the at least one key may be displayed in the key area until an application being executed on the second electronic device 104 is changed, the at least one key is modified, or a setting for the at least one key is changed.

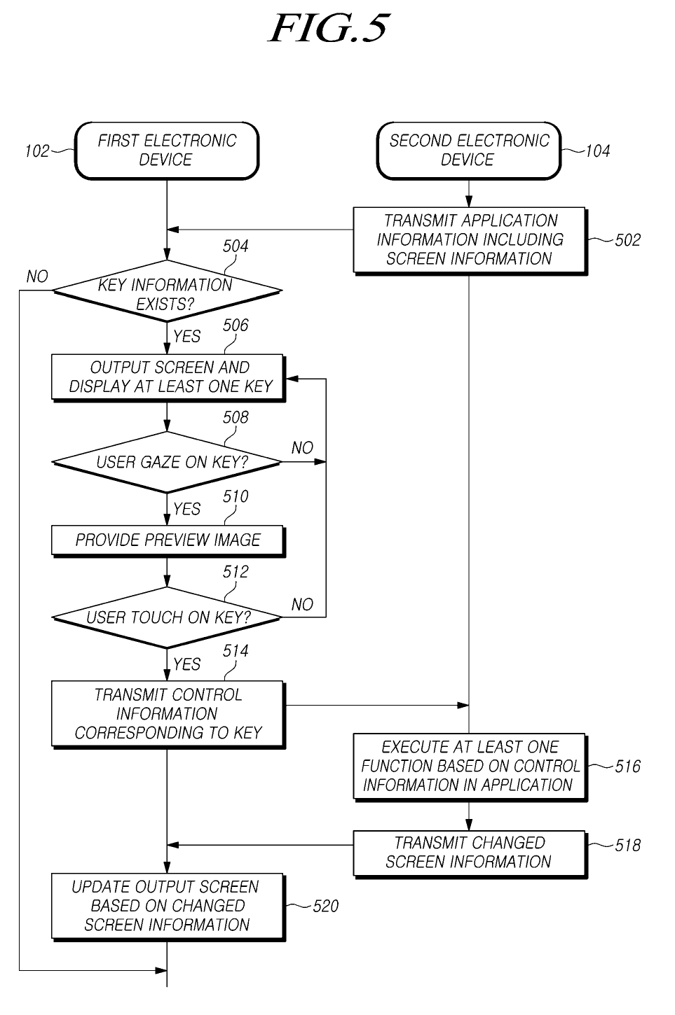

FIG. 5 is a flowchart illustrating operations of a first electronic device and a second electronic device for a key input associated with an application according to an embodiment of the disclosure.

Referring to FIG. 5, in operation 502, the second electronic device 104 may transmit application information including screen information to the first electronic device 102.

In operation 504, the first electronic device 102 may determine whether key information corresponding to the application information is present. The first electronic device 102 may terminate all operations in case that the key information corresponding to the application information is not present. The first electronic device 102 may perform operation 506 in case that the key information corresponding to the application information is present.

In operation 506, the first electronic device 102 may output a screen based on the screen information included in the application information, and display the at least one key based on the key information corresponding to the application information.

In operation 508, the first electronic device 102 may determine whether the user gaze corresponds to any one key among the at least one key. The first electronic device 102 may re-perform operation 506 in case that the user gaze does not correspond to any one key among the at least one key. The first electronic device 102 may perform operation 510 in case that the user gaze corresponds to any one key among the at least one key.

In operation 510, in response to the user gaze corresponding to any one key among the at least one key, the first electronic device 102 may provide a preview image associated with the key corresponding to the user gaze on the screen of the first electronic device 102.

In operation 512, the first electronic device 102 may determine whether a touch of the user is input to any one key among the at least one key. The first electronic device 102 may re-perform operation 506 in case that the touch of the user is not input to any one key among the at least one key. The first electronic device 102 may perform operation 514 in case that the touch of the user is input to any one key among the at least one key.

In operation 514, the first electronic device 102 may transmit control information corresponding to the key to which the touch of the user is input to the second electronic device 104.

In operation 516, the second electronic device 104 may receive the control information from the first electronic device 102, and execute at least one function based on the control information or generate at least one object based on the control information in the application.

In operation 518, the second electronic device 104 may transmit screen information changed as a result of executing the at least one function in the application to the first electronic device 102.

In operation 520, the first electronic device 102 may receive the changed screen information from the second electronic device 104, and update the output screen based on the changed screen information.

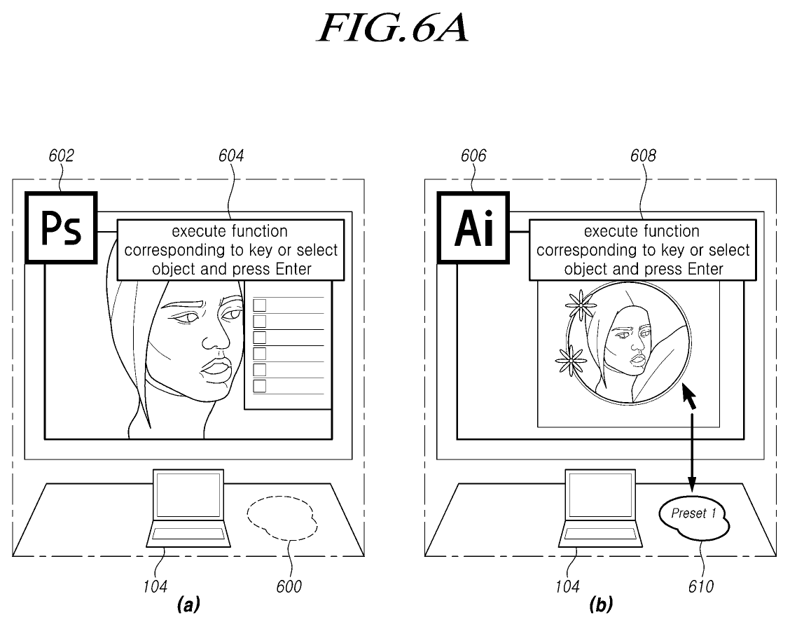

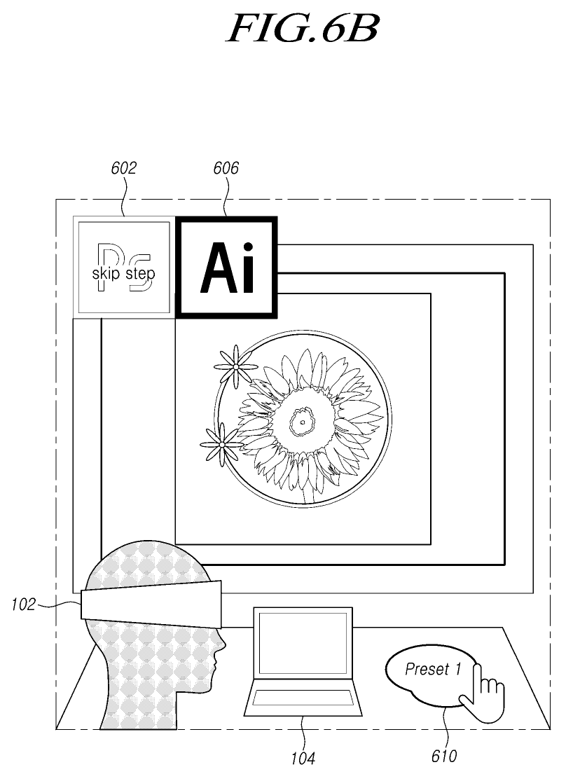

The at least one key (e.g., the first key 230 of FIG. 2C or the second key 308 of FIG. 3A) generation and input method described above may be variously applied and used in various environments. Examples related thereto is described below with reference to FIGS. 6A, 6B, 7A, 7B, 8A, 8B, 9A, 9B, 10A, 10B, 11, 12A, 12B and 12C. In the following description, the key area generation operation is similar to the operation described with reference to FIG. 2A, and the operation of setting information associated with a key is similar to the operation described with reference to FIGS. 2B and 3A, and thus, detailed description thereof is omitted.

FIG. 6A is a view illustrating execution screens of a plurality of applications for generating an integrated key according to an embodiment of the disclosure.

Referring to FIG. 6A, an integrated key associated with a plurality of applications may be generated based on a selection of the user. For example, an integrated key associated with an image editing application (hereinafter referred to as "Ps application") 602, such as Photoshop and an image creation application (hereinafter referred to as "Ai application") 606, such as Illustrator may be generated. According to an example, the Ps application 602 may be executed simultaneously with the Ai application 606 or may be executed before the Ai application 606.

According to an example, the user may set a key area 600 using the first electronic device 102, and set key information corresponding to the plurality of applications using the second electronic device 104.

Referring to part (a) of FIG. 6A, after the key area 600 is generated in the first electronic device 102, the second electronic device 104 may execute the information setting plug-in based on the selection of the user. For example, the second electronic device 104 may execute the information setting plug-in based on the selection of the user in a state in which the Ps application 602 is executed and an image editing task has been performed by the user.

According to an example, the execution screen of the information setting plug-in may include the execution screen of the Ps application 602 and a guidance message 604 (e.g., Execute a function to correspond to a key or select an object, and press Enter) for guiding an operation of the user. According to an example, in case that the user selects one or more functions or objects of the Ps application 602 used for the image editing task based on the guidance message 604, first key information based on the selected one or more functions or objects may be generated. For example, the first key information may include information associated with one or more functions or objects of the Ps application 602 used to generate the image edited by the user. The first key information may be generated by the second electronic device 104 performing an operation similar to the operation described with reference to FIGS. 2B or 3A.

According to an example, in case that the first key information is generated, the second electronic device 104 may terminate the Ps application 602 and execute the Ai application 606 according to the selection of the user. According to an example, the Ai application 606 may already be in an executed state.

The second electronic device 104 may perform an image creation task by additionally correcting the image edited by the Ps application 602 using the Ai application 606, based on the selection of the user. The second electronic device 104 may execute the information setting plug-in based on the selection of the user. According to an example, in case that the information setting plug-in is not terminated after the first key information is generated, it may still be in an executed state. In case that an application being used by the user is changed from the Ps application 602 to the Ai application 606, the information setting plug-in may display an execution screen as illustrated in part (b) of FIG. 6A.

Referring to part (b) of FIG. 6A, the execution screen of the information setting plug-in may include the execution screen of the Ai application 606 and a guidance message 608 (e.g., Execute a function to correspond to a key or select an object, and press Enter) for guiding an operation of the user. According to an example, in case that the user selects one or more functions or objects of the Ai application 606 used for the image creation task based on the guidance message 608, second key information based on the selected one or more functions or objects may be generated. For example, the second key information may be generated by the second electronic device 104 performing an operation similar to the operation described with reference to FIGS. 2B or 3A.

According to an example, the second electronic device 104 may generate integrated key information on the Ps application 602 and the Ai application 606 based on the first key information and the second key information. For example, the integrated key information may include information on one or more functions or objects of the Ps application 602 used by the user for the image editing task, and information on one or more functions or objects of the Ai application 606 used for the image creation task after the image editing task.

According to an example, the second electronic device 104 may transmit the integrated key information to the first electronic device 102. The first electronic device 102 may receive the integrated key information from the second electronic device 104, and store the received integrated key information as information associated with the Ps application 602 and the Ai application 606. The integrated key information may be used to generate an integrated key 610 in the first electronic device 102. The integrated key 610 may be displayed in the specified key area (e.g., the key area 600 of part (a) of FIG. 6A), and may be displayed based on a name or icon (e.g., Preset 1) or a color (e.g., gray) set by the user.

FIG. 6B is a view illustrating a screen on which a task based on a plurality of applications is performed using an integrated key according to an embodiment of the disclosure.

Referring to FIG. 6B, in case that the Ps application 602 and/or the Ai application 606 is executed on the second electronic device 104, the first electronic device 102 may receive executed application information from the second electronic device 104. The first electronic device 102 may display the integrated key 610 corresponding to the integrated key information based on the executed application information.

According to an example, in case that it is detected that the finger of the user is positioned on the integrated key 610 or the gaze of the user corresponds thereto, the first electronic device 102 may display a preview image. For example, the preview image may be an image associated with the Ps application 602 and/or the Ai application 606 (e.g., an image editing or creation related image).

According to an example, in response to the user touching the integrated key 610, the first electronic device 102 may transmit control information corresponding to the integrated key 610 to the second electronic device 104. For example, the control information corresponding to the integrated key 610 may include a first control command for controlling the Ps application 602 and a second control command for controlling the Ai application 606.

According to an example, the second electronic device 104 may perform an operation corresponding to the first control command associated with the Ps application 602 and the second control command associated with the Ai application 606, based on the control information received from the first electronic device 102. For example, the operation corresponding to the first control command may be performed before the operation corresponding to the second control command.

According to an example, the integrated key 610 may control all functions or objects of the plurality of applications. For example, in case that the control information corresponding to the integrated key 610 is transmitted to the second electronic device 104 in a state in which the Ai application 606 is executed, not only the functions or objects of the Ps application 602 but also the functions or objects of the Ai application 606 may be controlled based on the control information. As a result, the user may obtain a result to which editing and correction effects in the Ps application 602 and the Ai application 606 are applied. Accordingly, based on the integrated key 610, the user may use image editing or correction details created through several command steps using the plurality of applications equally in subsequent tasks.

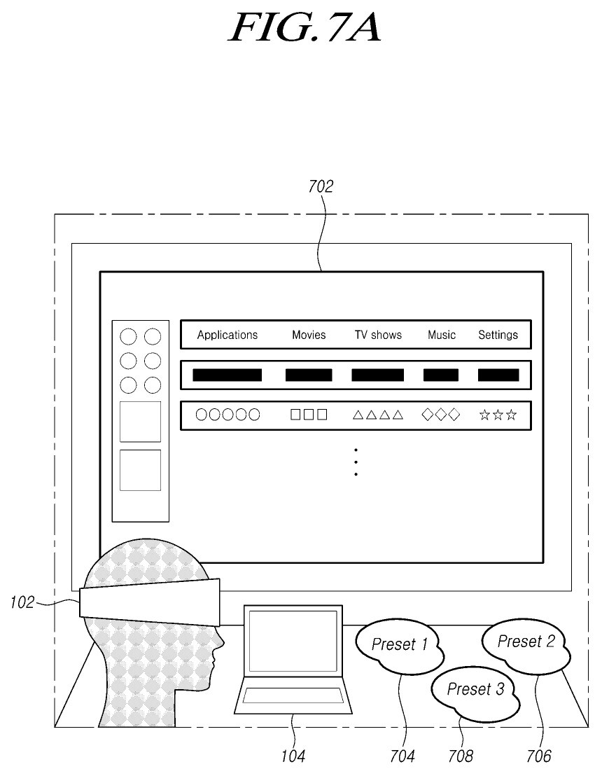

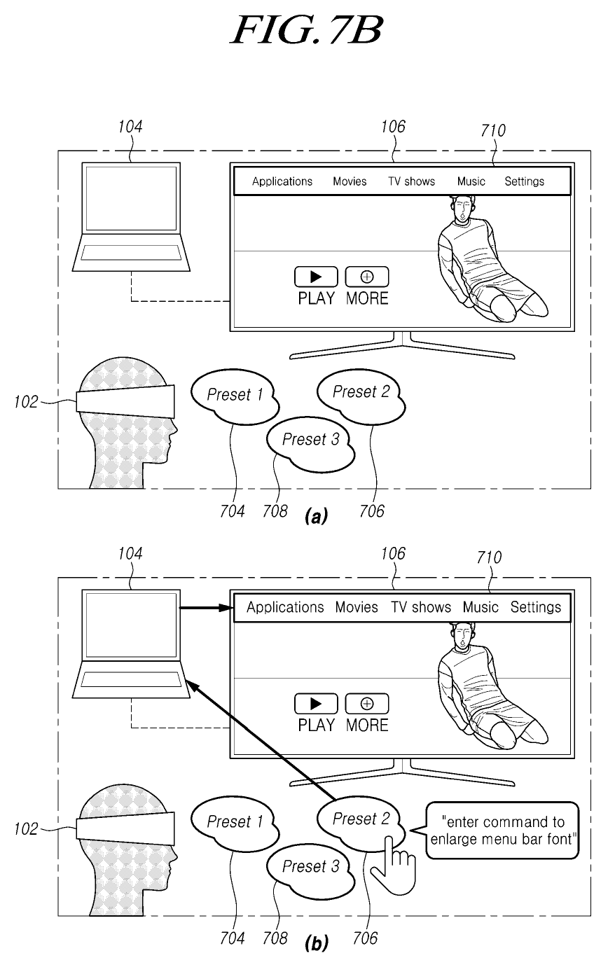

FIG. 7A is a view illustrating a screen on which a plurality of keys for a third electronic device linked with a second electronic device are generated according to an embodiment of the disclosure.

Referring to FIG. 7A, the second electronic device 104 may be linked with a third electronic device (e.g., a TV) including a display. For example, a third application executed on the second electronic device 104 may be displayed on the third electronic device wirelessly or wiredly connected to the second electronic device 104.

The second electronic device 104 may generate at least one key associated with the third application based on the selection of the user. For example, the second electronic device 104 may generate at least one key to be displayed on the third electronic device using an application UI design productivity application (e.g., Sketch, Figma, or the like) 702. For ease of understanding, hereinafter, the at least one key to be displayed on the third electronic device is referred to as a "TV key."

The user may set key information for modifying a design (or a design prototype) (e.g., at least one of a display position, a size, a color, or a font) of the TV key using the information setting plug-in of the second electronic device 104, and generate a plurality of keys based on the set key information using the first electronic device 102. For example, the plurality of keys may include keys (e.g., Preset 1 704, Preset 2 706, Preset 3 708) for performing a function of variously changing the design of the TV key. The plurality of keys may be augmented and displayed in a plurality of key areas generated by the first electronic device 102.

FIG. 7B is a view illustrating a screen on which a design of a TV key displayed on a third electronic device is controlled based on a plurality of keys according to an embodiment of the disclosure.

Referring to part (a) of FIG. 7B, the user may display the TV key 710 generated on the second electronic device 104 on a third electronic device 106, and may want to check and modify the design of the TV key 710 in real-time.

The second electronic device 104 may transmit information on the TV key 710 to the third electronic device 106 so that the TV key 710 may be displayed on the third electronic device 106. The third electronic device 106 may receive the information from the second electronic device 104 and display the TV key 710.

According to an example, in case that the user wearing the first electronic device 102 moves in front of the display of the third electronic device 106, the first electronic device 102 may display the plurality of keys (e.g., Preset 1 704, Preset 2 706, Preset 3 708) augmented at the set position. The set position may include, e.g., at least one of a surrounding area of the third electronic device 106, a space in the air or on a flat surface, a position within a set distance from the third electronic device 106, or a position designated by the user.

Referring to part (b) of FIG. 7B, in case that the TV key 710 has a menu bar form including characters of a specific font and any one of the plurality of keys (e.g., Preset 1 704, Preset 2 706, Preset 3 708) (e.g., Preset 2 706) is selected by the user, the first electronic device 102 may transmit control information (e.g., menu bar font enlargement command input) corresponding to the selected key to the second electronic device 104.

The second electronic device 104 may execute a function corresponding to the control information and transmit screen information corresponding to the executed function to the third electronic device 106. The third electronic device 106 may receive the screen information from the second electronic device 104 and update a screen being displayed based on the received screen information. For example, the updated screen may include the TV key 710 with an increased font size.

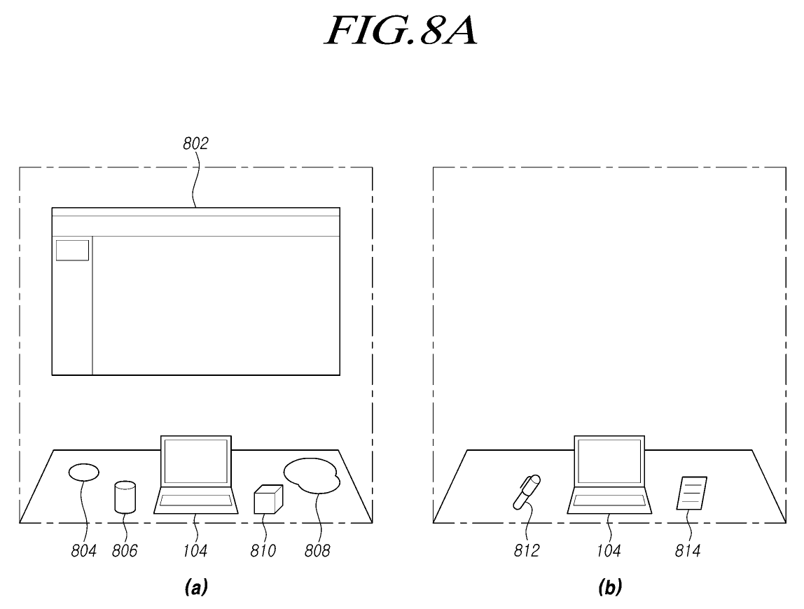

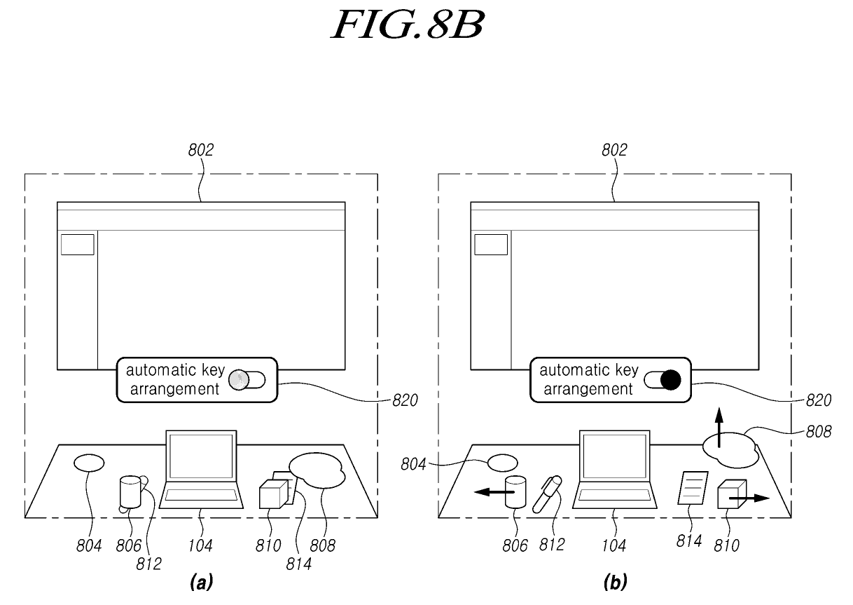

FIG. 8A is a view illustrating a change in a surrounding environment of a second electronic device according to an embodiment of the disclosure.

Referring to part (a) of FIG. 8A, the second electronic device 104 may execute an application 802, and the first electronic device 102 may display keys associated with the application 802 based on the selection of the user. The keys associated with the application 802 may be keys having a form and at least one function generated by the user, and may be displayed around the second electronic device 104 (or a keyboard of the second electronic device 104) according to the selection of the user. For example, the keys associated with the application 802 may be a first key 804, a second key 806, a third key 808, and a fourth key 810, and may be button-type keys having various forms (e.g., a circle, a cube, or a two-dimensional (2D) image) by an intention of the user.

Referring to part (b) of FIG. 8A, in a state in which the screen as illustrated in part (a) of FIG. 8A is displayed on the first electronic device 102, or in a state in which the user has temporarily taken off the first electronic device 102, or in a state in which the user has deactivated the keys (e.g., the first key 804, the second key 806, the third key 808, and the fourth key 810) associated with the application 802, the user may change the surrounding environment by placing various objects around the second electronic device 104. For example, the user may place a pen 812 and a paper 814 around the second electronic device 104.

FIG. 8B is a view illustrating a screen on which an automatic key arrangement function is executed in a first electronic device based on a change in a surrounding environment of a second electronic device according to an embodiment of the disclosure.

Referring to part (a) of FIG. 8B, after the user places the pen 812 and the paper 814 around the second electronic device 104, in case that the user puts on the first electronic device 102 that was taken off again, or in case that the user activates the keys associated with the application 802, at least one of the keys associated with the application 802 and at least one of the objects disposed by the user may be displayed overlapping around the second electronic device 104. For example, the second key 806, the third key 808, and the fourth key 810 associated with the application 802 and the pen 812 and the paper 814 disposed by the user may be displayed overlapping on the screen of the first electronic device 102 because their positions overlap.

According to an example, the first electronic device 102 may provide an automatic key arrangement function. For example, the first electronic device 102 may display an automatic key arrangement UI 820 enabling execution or release of the automatic key arrangement function on the screen. According to an example, the automatic key arrangement function may include a function for relocating the at least one first UI so as not to overlap the at least one object.

Referring to part (b) of FIG. 8B, in case that the user executes the automatic key arrangement function through the automatic key arrangement UI 820, the first electronic device 102 may identify keys (e.g., the second key 806, the third key 808, or the fourth key 810) overlapping objects (e.g., the pen 812 or the paper 814) disposed around the second electronic device 104. The first electronic device 102 may relocate the identified keys to a position (or alternate areas) not overlapping the objects disposed around the second electronic device 104.

For example, the first electronic device 102 may relocate the second key 806, the third key 808, and the fourth key 810 associated with the application 802 to a position not overlapping the pen 812 or the paper 814 disposed by the user. In case that the automatic key arrangement function is executed, the selection of the pen 812 or the paper 814 by the user may be clearly distinguished from the selection of the second key 806, the third key 808, or the fourth key 810 associated with the application 802 on the screen of the first electronic device 102.

According to an example, in case that the user moves the pen 812 or the paper 814 to a position different from the surrounding area of the second electronic device 104, the first electronic device 102 may return and display the second key 806, the third key 808, or the fourth key 810 to an initial setting position (e.g., the position illustrated in part (a) of FIG. 8A or part (a) of FIG. 8B).

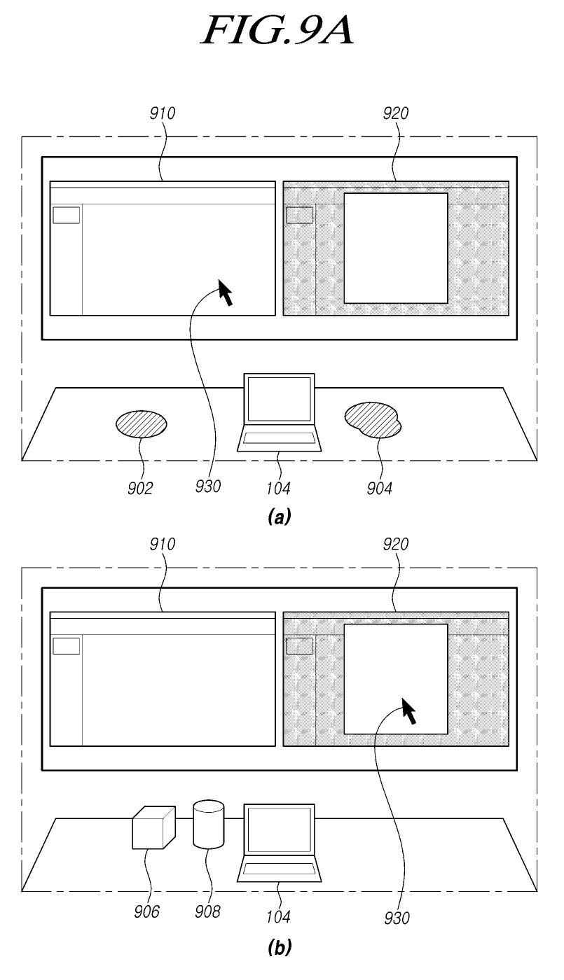

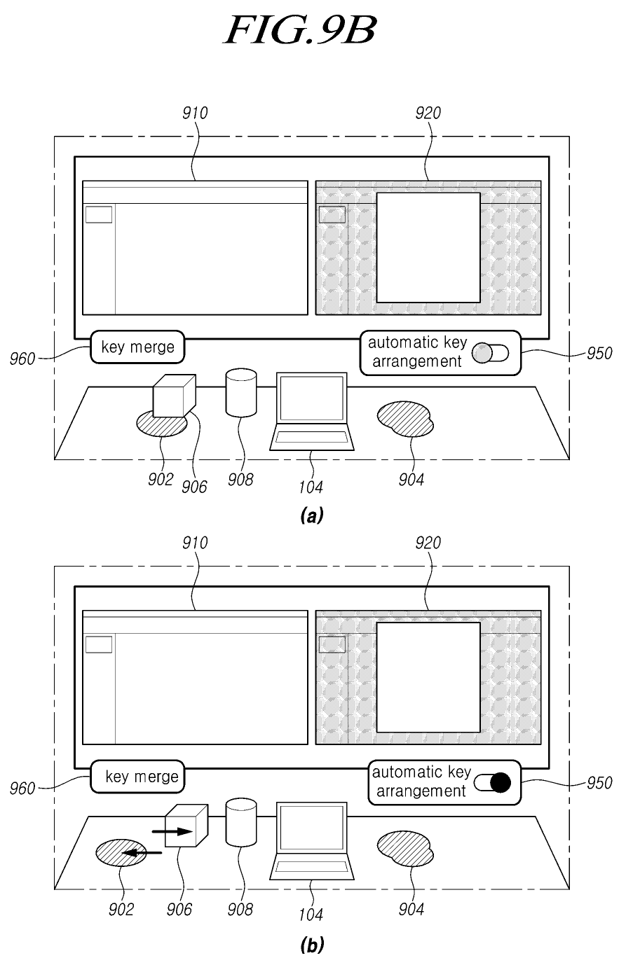

FIG. 9A is a view illustrating a screen on which a first electronic device displays a key corresponding to each of a plurality of applications according to an embodiment of the disclosure.

According to an example, the first electronic device 102 may set a key corresponding to each of the plurality of applications executed on the second electronic device 104. For example, the first electronic device 102 may set a first key 902 and a second key 904 corresponding to a first application 910, and may set a third key 906 and a fourth key 908 corresponding to a second application 920. Each of the first key 902, the second key 904, the third key 906, and the fourth key 908 may have a form and a function desired by the user, and may be displayed in a key area generated by the user. The first key 902 and the second key 904 may be used to control the first application 910, and the third key 906 and the fourth key 908 may be used to control the second application 920.

The second electronic device 104 may execute the first application 910 and the second application 920, and transmit application information associated with each of the executed first application 910 and the second application 920 to the first electronic device 102. The first electronic device 102 may receive the application information and display execution screens of the first application 910 and the second application 920 based on screen information included in the received application information.

According to an example, the first electronic device 102 may identify an application being used by the user among the first application 910 and the second application 920. For example, the first electronic device 102 may identify an application in which a mouse cursor 930 is operating or is positioned among the first application 910 and the second application 920, or an application on which the gaze of the user stays for a predetermined time or more, as the application being used by the user.

Referring to part (a) of FIG. 9A, in case that the mouse cursor 930 is operating or is positioned in the first application 910, the first electronic device 102 may identify the application being used by the user as the first application 910 and display the first key 902 and the second key 904 corresponding to the first application 910.

Referring to part (b) of FIG. 9A, in case that the mouse cursor 930 is operating or is positioned in the second application 920, the first electronic device 102 may identify the application being used by the user as the second application 920 and display the third key 906 and the fourth key 908 corresponding to the second application 920.

According to an example, the first electronic device 102 may change and display keys displayed on the screen each time an application being used by the user is changed. For example, in case that the user repeatedly performs an operation of alternately using the first application 910 and the second application 920, the first electronic device 102 may repeatedly perform screen transitions for key changes. According to an example, a display function as illustrated in FIG. 9B may be used to prevent repetitive screen transitions for key changes.

FIG. 9B is a view illustrating a screen on which a first electronic device merges and displays keys corresponding to each of a plurality of applications according to an embodiment.

Referring to part (a) of FIG. 9B, the first electronic device 102 may perform a key merge function of displaying the third key 906 and the fourth key 908 corresponding to the second application 920 together with the first key 902 and the second key 904 corresponding to the first application 910. In case that the first electronic device 102 performs the key merge function, the first electronic device 102 may display a message 960 indicating that the key merge function is being performed on the screen. In case that the first electronic device 102 performs the key merge function, the first electronic device 102 may not perform an operation of identifying an application being used by the user.

According to an example, in case that the key merge function is performed, while the user uses the first application 910, not only the first key 902 and the second key 904 but also the third key 906 and the fourth key 908 corresponding to the second application 920 may be displayed on the first electronic device 102. In case that the key merge function is performed, while the user uses the second application 920, not only the third key 906 and the fourth key 908 but also the first key 902 and the second key 904 corresponding to the first application 910 may be displayed on the first electronic device 102.

According to an example, in case that the key merge function is performed and at least two of the first key 902, the second key 904, the third key 906, or the fourth key 908 (e.g., the first key 902 and the third key 906) are displayed overlapping, the first electronic device 102 may execute the automatic key arrangement function. For example, the first electronic device 102 may display an automatic key arrangement UI 950 enabling execution or release of the automatic key arrangement function on the screen. According to an example, the automatic key arrangement function may include a function for relocating overlapping keys.

Referring to part (b) of FIG. 9B, in case that the user executes the automatic key arrangement function through the automatic key arrangement UI 950, the first electronic device 102 may relocate the first key 902 and the third key 906 so that the first key 902 and the third key 906 do not overlap each other. For example, the first electronic device 102 may change the display position of the first key 902 and the display position of the third key 906 to positions not overlapping each other.

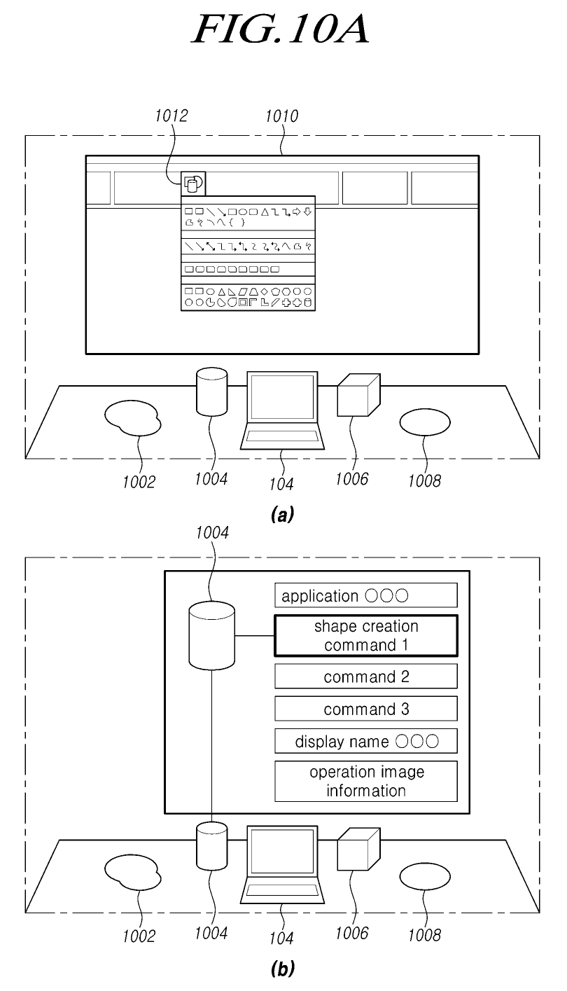

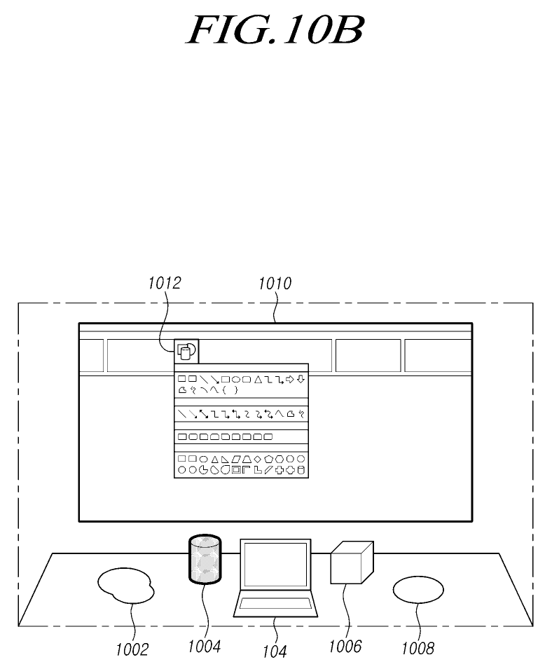

FIG. 10A is a view illustrating a screen on which a first electronic device identifies a key associated with a selected menu of an application according to an embodiment of the disclosure.

Referring to part (a) of FIG. 10A, in response to an application 1010 being executed on the second electronic device 104, the first electronic device 102 may display keys (e.g., a first key 1002, a second key 1004, a third key 1006, or a fourth key 1008) associated with the application 1010.

According to an example, the first electronic device 102 may identify whether a menu 1012 associated with figure creation (hereinafter referred to as "figure menu") among menus provided by the application 1010 has been selected by the user. For example, the first electronic device 102 may identify whether the figure menu 1012 of the application 1010 has been selected by the user on a screen being displayed on the second electronic device 104, based on information on the screen being displayed on the second electronic device 104. The first electronic device 102 may receive the information on the screen being displayed on the second electronic device 104 from the second electronic device 104 in real-time, or may obtain the same using a visual sensing device or a visual sensor (e.g., a camera) included in the first electronic device 102.

Referring to part (b) of FIG. 10A, in case that it is identified that the figure menu 1012 of the application 1010 has been selected by the user, the first electronic device 102 may identify at least one key associated with the figure menu 1012 among the keys associated with the application 1010. For example, the first electronic device 102 may identify at least one key associated with the figure menu 1012 based on information stored for each of the keys associated with the application 1010. The first electronic device 102 may identify information (e.g., figure creation command 1) related to figure creation in the information stored for each of the keys associated with the application 1010, and identify the at least one key (e.g., the second key 1004) associated with the identified information.

FIG. 10B is a view illustrating a screen on which a first electronic device visually emphasizes and displays a key associated with a selected menu of the application according to an embodiment of the disclosure.

Referring to FIG. 10B, the first electronic device 102 may visually emphasize and display the at least one key (e.g., the second key 1004) associated with the figure menu 1012 of the application 1010 selected by the user. For example, the first electronic device 102 may allow the user to identify the at least one key by setting a border or color of the at least one key to be different from other keys, or applying a visual emphasis effect (e.g., being represented more intensely than other keys or an effect as if the surroundings of the key are glowing) to the at least one key. According to an example, the user may more easily use a function related to figure creation of the application 1010 using the at least one key.

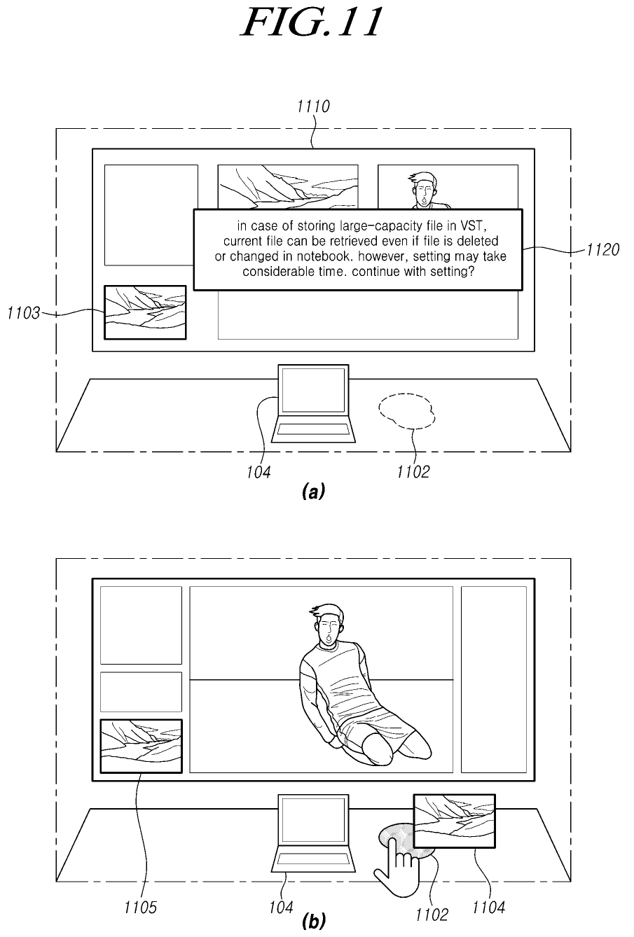

FIG. 11 is a view illustrating a screen on which a first electronic device provides a large-capacity object according to an embodiment of the disclosure.

Referring to part (a) of FIG. 11, the second electronic device 104 may execute an application 1110 (e.g., a video productivity application) capable of providing various capacities of an image, audio, video, a video effect, or a video source. In case that a key area 1102 is generated by the user, the first electronic device 102 may set an object associated with a key to be displayed in the key area 1102. For example, the first electronic device 102 may set at least one selected by the user among various capacities of an image, audio, video, a video effect, or a video source provided by the application 1110 as an object associated with the key.

According to an example, in case that the user selects a large-capacity object (e.g., a high-definition image or video file 1103) having a capacity equal to or greater than a set capacity as an object associated with the key, the first electronic device 102 may receive the large-capacity object from the second electronic device 104 and store the same as an object associated with the key. In case that the large-capacity object is stored in the first electronic device 102, the user may be provided with the large-capacity object stored in the first electronic device 102 using the key. For example, even in case that the large-capacity object is deleted or lost in the second electronic device 104, or in case that a storage position of the large-capacity object is changed, the user may be provided with the large-capacity object from the first electronic device 102.

According to an example, the first electronic device 102 may display a guidance message informing the user that setting takes time as the large-capacity object is selected, before storing the large-capacity object. For example, based on the first electronic device 102 being VST, the second electronic device 104 being a laptop, and the user selecting a large-capacity file as the large-capacity object, the first electronic device 102 may display a guidance message 1120 "In case that you store a large-capacity file in the VST, you may retrieve the current file even in case that the file is deleted or changed on the laptop. However, setting may take considerable time. Do you want to continue with the setting?" on the screen. The guidance message 1120 may be displayed on the execution screen of the application 1110 but, without limitations thereto, may be displayed at various positions.

According to an example, in case that the user continues with the setting based on the guidance message 1120, the first electronic device 102 may request the second electronic device 104 to provide the large-capacity object and receive the large-capacity object from the second electronic device 104 in response to the request. The first electronic device 102 may store the received large-capacity object and generate a key associated with the large-capacity object.

According to an example, the first electronic device 102 may provide the user with a setting option enabling the use of the large-capacity object stored in the second electronic device 104 without storing the large-capacity object in the first electronic device 102. According to an example, the large-capacity object stored in the second electronic device 104 may be stored as a local file at a set position. According to an example, the first electronic device 102 may provide information on the setting option to the user by adding the same to the guidance message 1120, or through a message different from the guidance message 1120.

Referring to part (b) of FIG. 11, in case that a key associated with a large-capacity object is set in the key area 1102 and the application 1110 is executed on the second electronic device 104, the first electronic device 102 may display the key in the key area 1102. The large-capacity object may be an object 1105 displayed on the execution screen of the application 1110, or an object not displayed on the execution screen of the application 1110. For example, in case that the large-capacity object is an object stored in the second electronic device 104, the large-capacity object may be displayed on the execution screen of the application 1110 and, in case that the large-capacity object is an object stored in the first electronic device 102, the large-capacity object may or may not be displayed on the execution screen of the application 1110.

In case that it is detected that the finger of the user is positioned on the displayed key or the gaze of the user corresponds to the key, the first electronic device 102 may display a preview image 1104. For example, the preview image 1104 may include an image associated with the large-capacity object.

In response to the user touching the key displayed in the key area 1102, the first electronic device 102 may display the large-capacity object. For example, in case that the large-capacity object is an object stored in the second electronic device 104, the first electronic device 102 may be provided with information on an execution screen of the large-capacity object from the second electronic device 104 in real-time and display the same on the screen. For example, in case that the large-capacity object is an object stored in the first electronic device 102, the first electronic device 102 may display the large-capacity object stored in the first electronic device 102 on the screen.

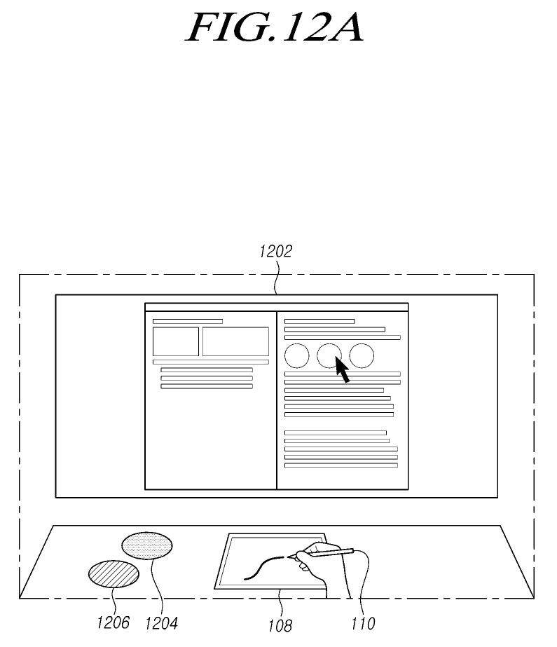

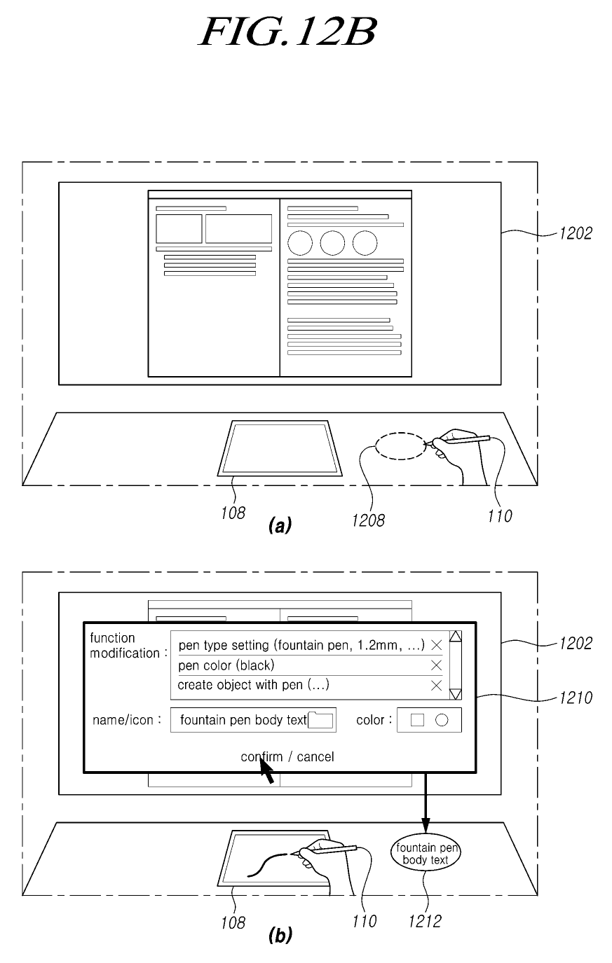

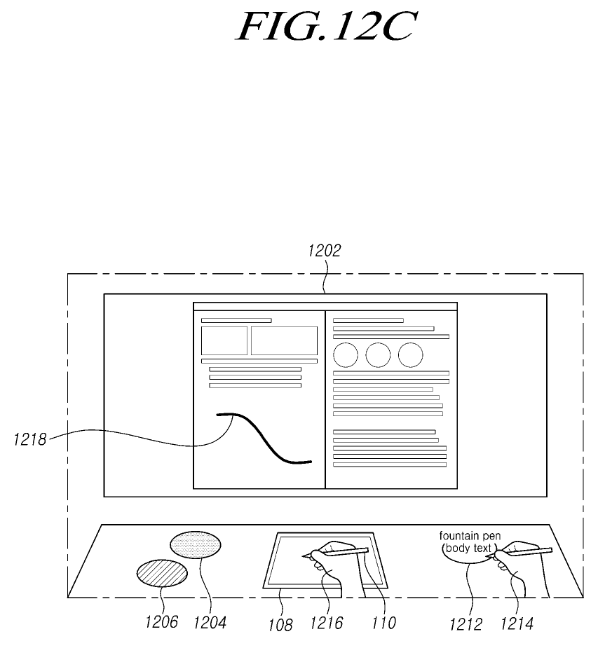

FIG. 12A is a view illustrating a screen on which an application is used based on a fourth electronic device linked with a first electronic device according to an embodiment of the disclosure.

Referring to FIG. 12A, the first electronic device 102 may be linked with a fourth electronic device 108. For example, the fourth electronic device 108 may be a mobile terminal or a tablet, and may be connected to the first electronic device 102 through wireless communication (e.g., Wi-Fi or Bluetooth communication). According to an example, together with the fourth electronic device 108, a separate input device (or an input accessory) 110 linked with the fourth electronic device 108 may be used. The input device 110 may be, e.g., a pen-type input device, such as an electronic pen, a stylus pen, or an S pen. Hereinafter, for convenience of description, the input device 110 is referred to as an electronic pen 110.

In case that an application 1202 (e.g., a note application) is executed on the fourth electronic device 108, the first electronic device 102 may display keys (e.g., a first key 1204 for a red pen input and a second key 1206 for generating a memo pad) set by the user in association with the application 1202. According to an example, the user may touch the second key 1206 to generate a memo pad, and touch the first key 1204 with the electronic pen 110 or a hand and perform an input on the fourth electronic device 108 to leave a record on the memo pad.

FIG. 12B is a view illustrating a screen on which a key associated with an electronic pen is generated in a first electronic device according to an embodiment of the disclosure.

Referring to part (a) of FIG. 12B, the first electronic device 102 may set a key area 1208 to generate a key associated with the electronic pen 110 while the application 1202 is being used. For example, the first electronic device 102 may set the key area 1208 based on drawing using the hand of the user or the electronic pen 110.

Referring to part (b) of FIG. 12B, the fourth electronic device 108 may execute the information setting plug-in based on the selection of the user. The fourth electronic device 108 may display an execution screen of the information setting plug-in. According to an example, the execution screen may include a message (e.g., Execute a function to correspond to a key or select an object, and press Enter) for guiding an operation of the user.

In response to the user executing one or more functions (e.g., a pen style setting function) of the application 1202 associated with the electronic pen 110 based on the displayed message, the fourth electronic device 108 may display a window 1210 for allowing the user to set control information corresponding to the key on the screen.

According to an example, the fourth electronic device 108 may display one or more control commands for controlling one or more functions selected by the user. For example, the fourth electronic device 108 may display control commands, such as "pen type setting, pen color, object creation with pen, pen thickness, pen sharpness, or pen pressure sensitivity" associated with the pen style setting function. The user may select all or some of the control commands displayed on the fourth electronic device 108 as control information corresponding to the key. According to an example, in case that a UI displayed as "X" corresponding to at least one (e.g., object creation with pen) of the displayed control commands is selected, the fourth electronic device 108 may exclude the at least one control command corresponding to the selected UI from the control information.

According to an example, in case that at least one of the one or more control commands is a control command requiring a numerical setting, the corresponding numerical value may be set or modified by the user. For example, the thickness of the pen may be set to "1.2mm" or may be modified from a default value of "1.0mm" to "1.2mm" set by the user.

According to an example, in case that at least one of the one or more control commands is a function requiring an input or a selection of the user, the input or the selection of the user may be preset. For example, the pen color may be preset to "black" selected by the user.

According to an example, at least one of a name, an icon, a color, a font, or a visual effect corresponding to the key may be set by the user. For example, the name of the key may be set to "Fountain pen body," and the color may be set to "gray."

According to an example, in case that an input of the user indicating that information (e.g., control information corresponding to the key and information on at least one of a name, an icon, a color, a font, or a visual effect corresponding to the key) setting has been completed is received, the fourth electronic device 108 may transmit the set information as key information to the first electronic device 102.

The first electronic device 102 may receive the key information from the fourth electronic device 108 and store the received key information as information associated with the application 1202.

In case that the application 1202 is executed on the fourth electronic device 108, the first electronic device 102 may receive application information associated with the application 1202 from the fourth electronic device 108. The first electronic device 102 may identify the key information associated with the application 1202 based on the received application information, and display a key 1212 based on the identified key information.

According to an example, the key 1212 may be displayed in the key area 1208 set by the user. According to an example, the first electronic device 102 may display the key 1212 as an icon having text of "fountain pen body" in gray in the key area 1208, based on name information of the key 1212 (e.g., fountain pen body) and color information of the key 1212 (e.g., gray).

FIG. 12C is a view illustrating a screen on which a key associated with an electronic pen is used in a first electronic device according to an embodiment of the disclosure.

Referring to FIG. 12C, in response to the user touching the key 1212 with a hand 1214 or the electronic pen 110, the first electronic device 102 may transmit control information (e.g., pen type setting (fountain pen, 1.2mm, ...) and pen color (black)) to the fourth electronic device 108. The fourth electronic device 108 may control the pen style setting function of the application 1202 based on the received control information. For example, the fourth electronic device 108 may set the pen type to a fountain pen of 1.2mm, and set the pen color to black, based on the received control information.

After the user touches the key 1212, in case that the user performs an input operation on the fourth electronic device 108 using a hand 1216 or the electronic pen 110, the first electronic device 102 may transmit input information (e.g., handwriting information of the user or drawing information of the user) input to the fourth electronic device 108 to the fourth electronic device 108.

The fourth electronic device 108 may receive the input information from the first electronic device 102 and add an input 1218 corresponding to the received input information to a memo pad in the application 1202. According to an example, the input 1218 added to the memo pad may be input in the pen style set by the user. For example, the input 1218 written in a black fountain pen style of 1.2mm may be added to the memo pad.

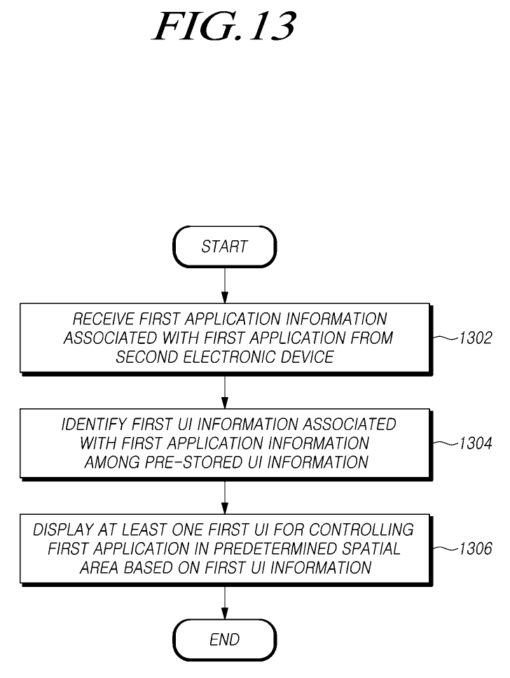

Hereinafter, an operation of the first electronic device 102 is described with reference to FIGS. 13 to 20.

FIG. 13 is a flowchart illustrating an operation of a first electronic device displaying at least one UI associated with a first application according to an embodiment of the disclosure.

Referring to FIG. 13, in operation 1302, the first electronic device 102 may receive first application information associated with the first application from the second electronic device 104.

In operation 1304, the first electronic device 102 may identify first UI information (e.g., key information or user setting information) associated with the first application information among pre-stored UI information.

In operation 1306, the first electronic device 102 may display at least one first UI (e.g., at least one first key) for controlling the first application in a predetermined spatial area (or a specified spatial area) based on the first UI information. According to an example, the at least one first UI may be generated based on user setting information (or key information) provided from the second electronic device 104. According to an example, the user setting information may include information indicating at least one control command selected by the user among one or more control commands for controlling the first application, and information indicating at least one of a name, an icon, a color, a font, or a visual effect set by the user corresponding to the at least one first UI.

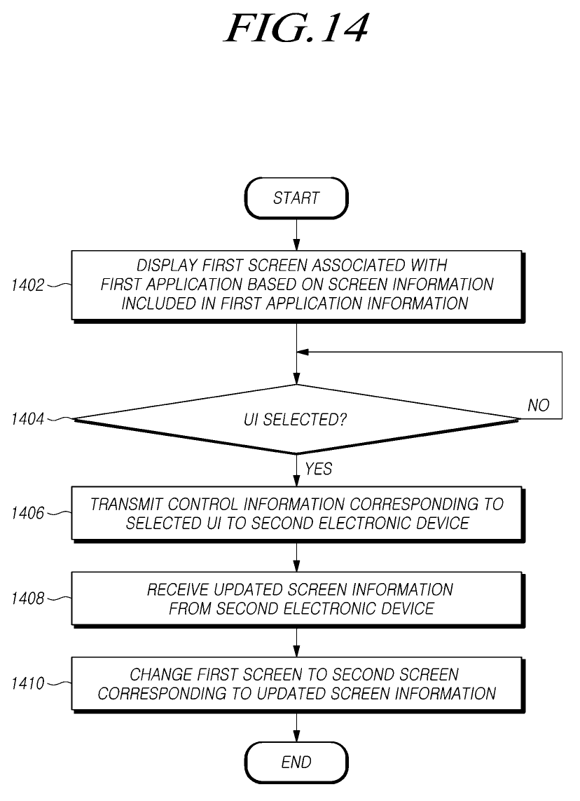

FIG. 14 is a flowchart illustrating an operation of a first electronic device controlling a first application based on a UI selected by a user according to an embodiment of the disclosure.

Referring to FIG. 14, in operation 1402, the first electronic device 102 may display a first screen associated with the first application based on screen information included in the first application information. For example, the first screen may include an execution screen of the first application.

In operation 1404, the first electronic device 102 may determine whether any one UI among the at least one first UI has been selected by the user. The first electronic device 102 may wait for a selection of the user in case that a UI has not been selected by the user, and may perform operation 1406 in case that a UI has been selected by the user.

In operation 1406, the first electronic device 102 may transmit control information corresponding to the UI selected by the user to the second electronic device 104.

In operation 1408, the first electronic device 102 may receive updated screen information from the second electronic device 104 in response to transmitting the control information. According to an example, the updated screen information may include information on an execution screen of the first application changed based on a function being performed or an object being selected based on the control information in the first application.

In operation 1410, the first electronic device 102 may change the first screen being displayed to a second screen corresponding to the updated screen information, based on receiving the updated screen information.

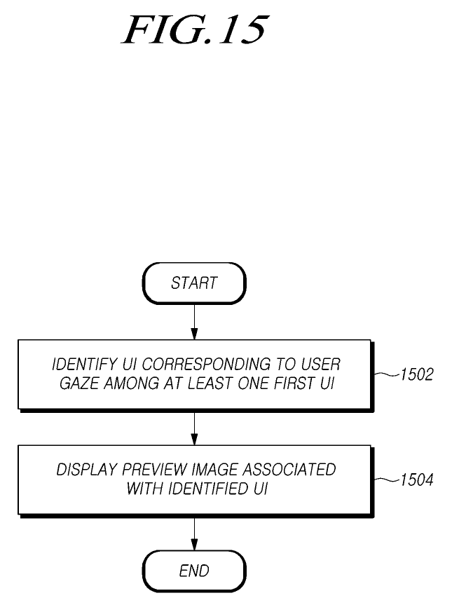

FIG. 15 is a flowchart illustrating an operation of a first electronic device displaying a preview image associated with a UI according to an embodiment of the disclosure.

Referring to FIG. 15, in operation 1502, the first electronic device 102 may identify a UI corresponding to the gaze of the user (or the finger of the user) among the at least one first UI.

In operation 1504, the first electronic device 102 may display a preview image associated with the identified UI. According to an example, the preview image may include an image associated with a function or an object corresponding to the identified UI, and may be displayed at a position designated by the user or a position associated with the identified UI.

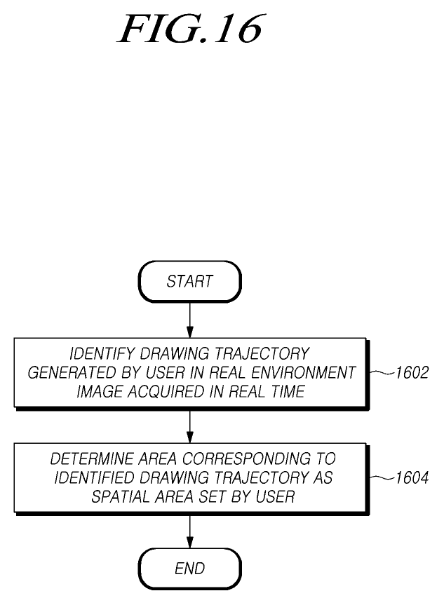

FIG. 16 is a flowchart illustrating an operation of a first electronic device generating a spatial area for displaying a UI according to an embodiment of the disclosure.

Referring to FIG. 16, in operation 1602, the first electronic device 102 may identify a drawing trajectory generated by the user in a real environment image obtained in real-time. According to an example, the drawing trajectory generated by the user may be a trajectory forming an area generated by the finger of the user.

In operation 1604, the first electronic device 102 may determine an area corresponding to the identified drawing trajectory as a spatial area set by the user. According to an example, the determined spatial area may include a spatial area or a UI area where the at least one first UI is displayed, and may be referred to as a key area.

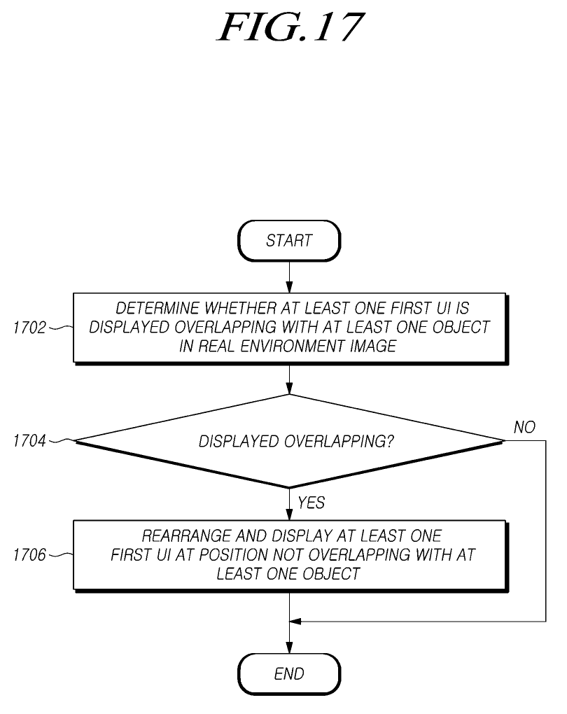

FIG. 17 is a flowchart illustrating a UI relocation operation of a first electronic device according to an embodiment of the disclosure.

Referring to FIG. 17, in operation 1702, the first electronic device 102 may determine whether the at least one first UI is displayed overlapping at least one object within the real environment image.

In operation 1704, in case that the at least one first UI is not displayed overlapping the at least one object within the real environment image, the first electronic device 102 may terminate all operations. The first electronic device 102 may perform operation 1706 in case that the at least one first UI is displayed overlapping the at least one object within the real environment image.

In operation 1706, the first electronic device 102 may relocate and display the at least one first UI at a position not overlapping the at least one object, based on the at least one first UI being displayed overlapping the at least one object within the real environment image.

According to an example, in case that the at least one first UI is a plurality of UIs and at least two UIs among the plurality of UIs overlap, the first electronic device 102 may relocate the at least two UIs to positions not overlapping each other.

According to an example, in case that the at least one first UI is displayed together with at least one second UI associated with the second application on the first electronic device 102 and the at least one first UI and the at least one second UI overlap, the first electronic device 102 may relocate the at least one first UI and/or the at least one second UI so as not to overlap each other.

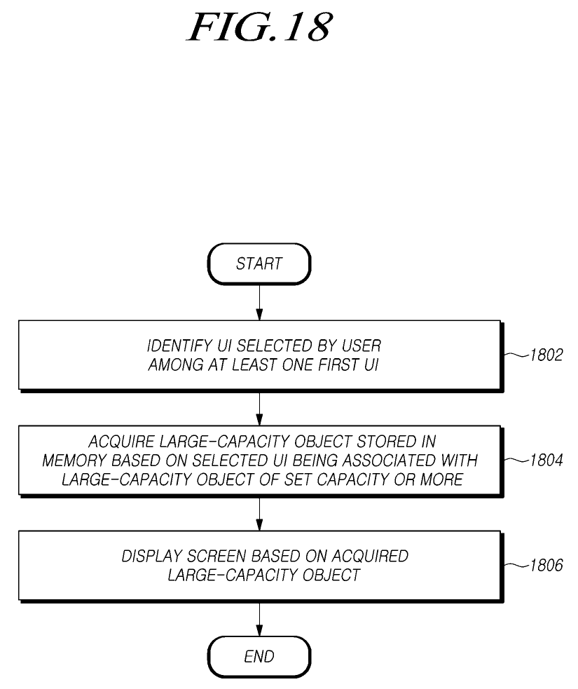

FIG. 18 is a flowchart illustrating an operation of a first electronic device displaying a large-capacity object according to an embodiment of the disclosure.

Referring to FIG. 18, in operation 1802, the first electronic device 102 may identify a UI selected by the user among the at least one first UI.

In operation 1804, the first electronic device 102 may obtain a large-capacity object stored in the memory of the first electronic device 102, based on the selected UI being associated with a large-capacity object having a capacity equal to or greater than a set capacity. According to an example, the large-capacity object may include at least one of an image, audio, or video provided from the second electronic device 104. According to an example, the first electronic device 102 may obtain the large-capacity object from the second electronic device 104 instead of from the memory of the first electronic device 102, based on a setting of the user. For example, in case that the user has not stored the large-capacity object in the first electronic device 102, the first electronic device 102 may be provided with the large-capacity object from the second electronic device 104.

In operation 1806, the first electronic device 102 may display a screen based on the obtained large-capacity object (e.g., a high-definition image or video screen or a high-quality audio playback screen).

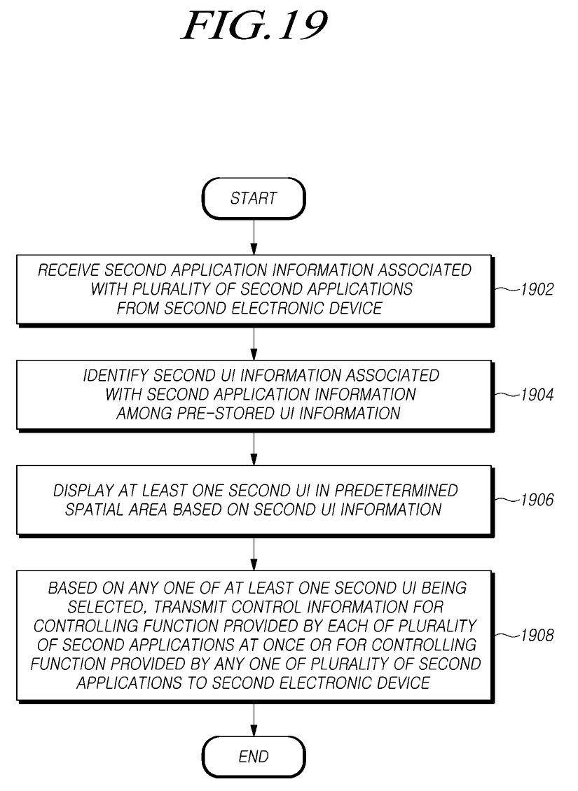

FIG. 19 is a flowchart illustrating an operation of a first electronic device displaying a UI associated with a plurality of applications according to an embodiment of the disclosure.

Referring to FIG. 19, in operation 1902, the first electronic device 102 may receive second application information associated with a plurality of second applications from the second electronic device 104. According to an example, the second application information may include information on each of the plurality of second applications.

In operation 1904, the first electronic device 102 may identify second UI information associated with the second application information among the pre-stored UI information. According to an example, the second UI information may include UI information corresponding to each of the plurality of applications.

In operation 1906, the first electronic device 102 may display at least one second UI in a predetermined spatial area (or a specified spatial area) (e.g., a key area) based on the second UI information. According to an example, the at least one second UI may include at least one of at least one UI (e.g., the integrated key 610 of FIG. 6B) for controlling functions provided by each of the plurality of second applications at once, or a plurality of UIs (e.g., the first key 902, the second key 904, the third key 906, and the fourth key 908 of FIGS. 9A and 9B) for respectively controlling functions provided by each of the plurality of second applications.

In operation 1908, the first electronic device may transmit control information for controlling functions provided by each of the plurality of second applications at once, or for controlling a function provided by any one of the plurality of second applications, based on any one of the at least one second UI being selected, to the second electronic device.

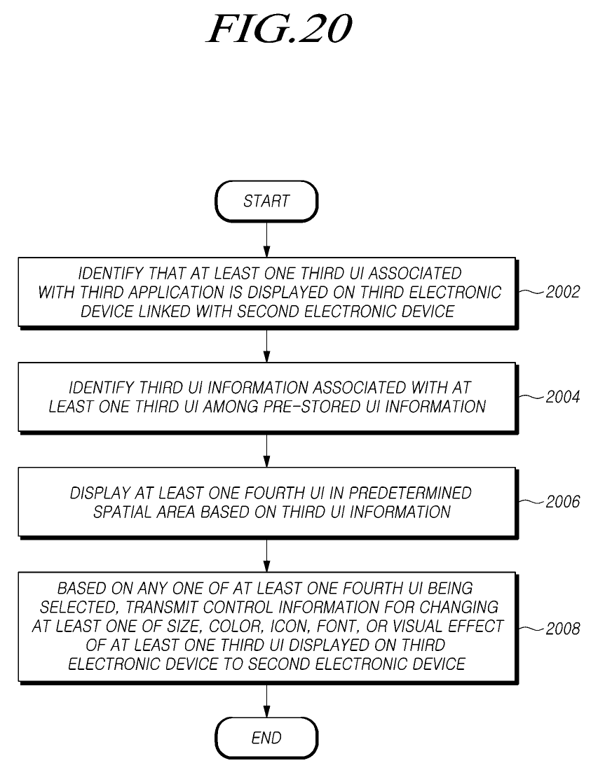

FIG. 20 is a flowchart illustrating an operation of a first electronic device changing a design of a UI displayed on a third electronic device according to an embodiment of the disclosure.

Referring to FIG. 20, in operation 2002, the first electronic device 102 may identify that at least one third UI (e.g., the TV key 710 of FIG. 7B) associated with the third application is displayed on a third electronic device 106 (e.g., a TV) linked with the second electronic device 104.

In operation 2004, the first electronic device 102 may identify third UI information associated with the at least one third UI among the pre-stored UI information.

In operation 2006, the first electronic device 102 may display at least one fourth UI in a predetermined spatial area (or a specified spatial area) (e.g., a key area) based on the third UI information. According to an example, the at least one fourth UI may include at least one UI for changing a design of the at least one third UI displayed on the third electronic device.

In operation 2008, the first electronic device 102 may transmit control information for changing at least one of a size, a color, an icon, a font, or a visual effect of the at least one third UI displayed on the third electronic device, based on any one of the at least one fourth UI being selected, to the second electronic device 104.

According to an example, in case that the design of the at least one third UI is changed based on the control information in the second electronic device 104, the first electronic device 102 may receive screen information from the second electronic device 104. The first electronic device 102 may update a screen being displayed based on the received screen information. The updated screen may include the at least one third UI with the changed design.

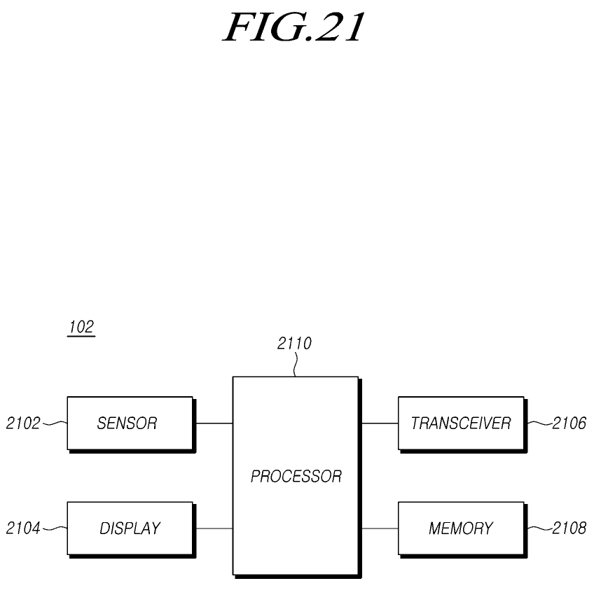

FIG. 21 is a block configuration diagram illustrating a first electronic device according to an embodiment of the disclosure.

Referring to FIG. 21, the first electronic device 102 may include a sensor 2102, a display 2104, a transceiver 2106, memory 2108, and a processor 2110. According to an example, the first electronic device 102 may include additional components (e.g., an audio output unit) other than the illustrated components, or may omit at least one of the illustrated components.

According to an example, the sensor 2102 may include at least one of a visual sensor (e.g., a camera) capable of sensing, collecting, and processing visual information, a gaze tracking sensor capable of tracking the gaze (or the movement of the pupil) of the user, or a gesture detection sensor capable of detecting a hand motion of the user. According to an example, the visual sensor, the gaze tracking sensor, or the gesture detection sensor may be physically separated or integrated into one and included in the sensor 2102.

According to an example, the display 2104 may perform various display operations according to the functions of the first electronic device 102. For example, the display 2104 may display an execution screen of the at least one application, a screen for setting the at least one UI or key, the at least one spatial area or key area, or the at least one UI or key that has been set.

According to an example, the transceiver 2106 may perform communication with at least one electronic device (e.g., the second electronic device 104 and/or the fourth electronic device 108). For example, the transceiver 2106 may perform communication with the at least one electronic device based on Wi-Fi, Bluetooth, or other communication technologies.

According to an example, the memory 2108 may store various information, data, or large-capacity objects associated with operations of the first electronic device 102, and may store at least one program.

According to an example, the processor 2110 may be electrically or operatively connected to the sensor 2102, the display 2104, the transceiver 2106, and the memory 2108, and may execute at least one instruction of a program stored in the memory 2108. There may be provided one or more processors 2110 which may perform the operations of the first electronic device 102 described above (e.g., the operations of the first electronic device 102 described with reference to FIGS. 1, 2A, 2B, 2C, 3A, 3B, 4, 5, 6A, 6B, 7A, 7B, 8A, 8B, 9A, 9B, 10A, 10B, 11, 12A, 12B, 12C, 13, 14, 15, 16, 17, 18, 19 and 20.

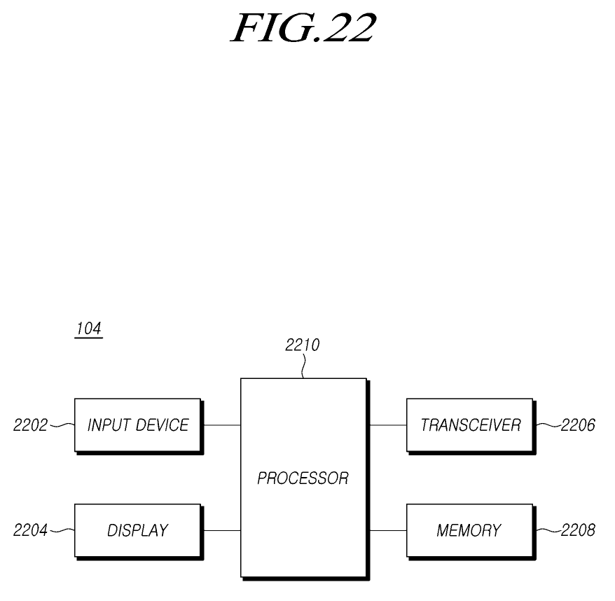

FIG. 22 is a block configuration diagram illustrating a second electronic device according to an embodiment of the disclosure.

Referring to FIG. 22, the second electronic device 104 may include an input device (or input unit) 2202, a display 2204, a transceiver 2206, memory 2208, and a processor 2210. According to an example, the second electronic device 104 may include additional components (e.g., an audio output unit) other than the illustrated components, or may omit at least one of the illustrated components.

According to an example, the input device 2202 may be an interface for a user input, and may include a keyboard, a mouse, or a touch screen. For example, the input device 2202 may support an input for executing or terminating an application, an input for executing or terminating the information setting plug-in, or an input for setting control information on an execution screen of the information setting plug-in.

According to an example, the display 2204 may perform various display operations according to functions of the second electronic device 104. For example, the display 2204 may display an execution screen of the at least one application or an execution screen of the information setting plug-in.

According to an example, the transceiver 2206 may perform communication with at least one electronic device (e.g., the first electronic device 102 and/or the third electronic device 106). For example, the transceiver 2206 may perform communication with the at least one electronic device based on Wi-Fi, Bluetooth, or other communication technologies.

According to an example, the memory 2208 may store various information, data, or large-capacity objects associated with operations of the second electronic device 104, and may store at least one program.

According to an example, the processor 2210 may be electrically or operatively connected to the input device 2202, the display 2204, the transceiver 2206, and the memory 2208, and may execute at least one instruction of a program in the memory 2208. There may be provided one or more processors 2210 which may perform the operations of the second electronic device 104 described above (e.g., the operations of the second electronic device 104 described with reference to FIGS. 1, 2A, 2B, 2C, 3A, 3B, 4, 5, 6A, 6B, 7A, 7B, 8A, 8B, 9A, 9B, 10A, 10B, 11, 12A, 12B and 12C).

The various embodiments of this document and the terms used herein are not intended to limit the technical features described in this document to specific embodiments of the disclosure, and should be understood to include various modifications, equivalents, or alternatives of the corresponding embodiments. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element.

As used herein, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment of the disclosure, the module may be implemented in a form of an application-specific integrated circuit (ASIC).

According to various embodiments of the disclosure, each component (e.g., a module or a program) of the above-described components may include a single entity or multiple entities. Some of the plurality of entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A first electronic device comprising:
a sensor;
a display;
a transceiver;
memory, comprising one or more storage media, storing instructions; and
at least one processor communicatively coupledto the sensor, the display, the transceiver, and the memory,
wherein the instructions, when executed by the at least one processor individually or collectively, cause the first electronic device to:
receive, from a second electronic device, first application information associated with a first application executed on the second electronic device,
in response to receiving the first application information, identify first user interface (UI) information associated with the first application information among UI information stored in the memory, and
based on the first UI information, control the display to display at least one first UI for controlling the first application in a specified spatial area,
wherein the specified spatial area includes a spatial area set by a user within a real environment image obtained in real-time by the sensor.

2. The first electronic device of claim 1, wherein the instructions, when executed by the at least one processor individually or collectively, furthercause the first electronic device to:
control the display to display a first screen associated with the first application based on screen information included in the first application information,
determine whether any one of the at least one first UI has been selected by the user,
based on any one of the at least one first UI being selected by the user, control the transceiver to transmit control information corresponding to the selected UI to the second electronic device,
in response to transmitting the control information, receive updated screen information from the second electronic device through the transceiver, and
based on receiving the updated screen information, control the display to change the first screen to a second screen corresponding to the updated screen information.

3. The first electronic device of claim 1,
wherein the at least one first UI is generated based on user setting information provided from the second electronic device, and
wherein the user setting information includes information indicating at least one control command selected by the user among one or more control commands for controlling the first application, and information indicating at least one of a name, an icon, a color, a font, or a visual effect set by the user corresponding to the at least one first UI.

4. The first electronic device of claim 1,
wherein the sensor is further configured to detect a gaze of the user, and
wherein the instructions, when executed by the at least one processor individually or collectively, furthercause the first electronic device to:
identify a UI corresponding to the gaze of the user among the at least one first UI, and
control the display to display a preview image associated with the identified UI.

5. The first electronic device of claim 1, wherein the instructions, when executed by the at least one processor individually or collectively, furthercause the first electronic device to:
identify a drawing trajectory generated by the user in the real environment image obtained in real-time by the sensor, and
determine an area corresponding to the identified drawing trajectory as a spatial area set by the user.

6. The first electronic device of claim 1, wherein the instructions, when executed by the at least one processor individually or collectively, furthercause the first electronic device to:
determine whether the at least one first UI is displayed overlapping at least one object within the real environment image, and
based on the at least one first UI being displayed overlapping the at least one object, control the display to relocate and display the at least one first UI at a position not overlapping the at least one object.

7. The first electronic device of claim 1,
wherein the instructions, when executed by the at least one processor individually or collectively, furthercause the first electronic device to:
identify a UI selected by the user among the at least one first UI,
based on the selected UI being associated with a large-capacity object having a capacity equal to or greater than a set capacity, obtain the large-capacity object stored in the memory, and
control the display to display a screen based on the obtained large-capacity object, and
wherein the large-capacity object includes at least one of an image, audio, or video provided from the second electronic device.

8. The first electronic device of claim 1,
wherein the instructions, when executed by the at least one processor individually or collectively, furthercause the first electronic device to:
receive, from the second electronic device, second application information associated with a plurality of second applications executed on the second electronic device,
in response to receiving the second application information, identify second UI information associated with the second application information among the pre-stored UI information, and
control the display to display at least one second UI in the specified spatial area based on the second UI information, and
wherein the at least one second UI includes at least one of at least one UI for controlling functions provided by each of the plurality of second applications at once, or a plurality of UIs for separately controlling functions provided by each of the plurality of second applications.

9. The first electronic device of claim 1,
wherein the instructions, when executed by the at least one processor individually or collectively, furthercause the first electronic device to:
identify that at least one third UI associated with a third application executed on the second electronic device is displayed on a third electronic device linked with the second electronic device,
based on the at least one third UI being displayed on the third electronic device, identify third UI information associated with the at least one third UI among the pre-stored UI information, and
control the display to display at least one fourth UI in the specified spatial area based on the third UI information, and
wherein the at least one fourth UI includes at least one UI for changing at least one of a size, a color, an icon, a font, or a visual effect of the at least one third UI displayed on the third electronic device.

10. The first electronic device of claim 1, wherein the at least one first UI includes at least one UI for controlling at least one function provided by the first application using an input device of a fourth electronic device linked with the first electronic device.

11. A method for providing a user interface (UI) by a first electronic device, the method comprising:
receiving, by the first electronic device, from a second electronic device, first application information associated with a first application executed on the second electronic device;
in response to receiving the first application information, identifying, by the first electronic device, first UI information associated with the first application information among stored UI information; and
based on the first UI information, displaying, by the first electronic device, at least one first UI for controlling the first application in a specified spatial area,
wherein the specified spatial area includes a spatial area set by a user within a real environment image obtained in real-time by the first electronic device.

12. The method of claim 11, further comprising:
displaying a first screen associated with the first application based on screen information included in the first application information;
determining whether any one of the at least one first UI has been selected by the user;
based on any one of the at least one first UI being selected by the user, transmitting control information corresponding to the selected UI to the second electronic device;
in response to transmitting the control information, receiving updated screen information from the second electronic device; and
based on receiving the updated screen information, changing the first screen to a second screen corresponding to the updated screen information.

13. The method of claim 11,
wherein the at least one first UI is generated based on user setting information provided from the second electronic device, and
wherein the user setting information includes information indicating at least one control command selected by the user among one or more control commands for controlling the first application, and information indicating at least one of a name, an icon, a color, a font, or a visual effect set by the user corresponding to the at least one first UI.

14. The method of claim 11, further comprising:
identifying a UI corresponding to a gaze of the user among the at least one first UI; and
displaying a preview image associated with the identified UI.

15. The method of claim 11, further comprising:
identifying a drawing trajectory generated by the user in the real environment image obtained in real-time; and
determining an area corresponding to the identified drawing trajectory as a spatial area set by the user.

16. The method of claim 11, further comprising:
determining whether the at least one first UI is displayed overlapping at least one object within the real environment image; and
based on the at least one first UI being displayed overlapping the at least one object, controlling the display to relocate and display the at least one first UI at a position not overlapping the at least one object.

17. The method of claim 11, further comprising: identifying a UI selected by the user among the at least one first UI; based on the selected UI being associated with a large-capacity object having a capacity equal to or greater than a set capacity, obtaining the large-capacity object stored in memory; and controlling the display to display a screen based on the obtained large-capacity object,
wherein the large-capacity object includes at least one of an image, audio, or video provided from the second electronic device.

18. The method of claim 11, further comprising: receiving, from the second electronic device, second application information associated with a plurality of second applications executed on the second electronic device; in response to receiving the second application information, identifying second UI information associated with the second application information among the pre-stored UI information; and controlling the display to display at least one second UI in the specified spatial area based on the second UI information,
wherein the at least one second UI includes at least one of at least one UI for controlling functions provided by each of the plurality of second applications at once, or a plurality of UIs for separately controlling functions provided by each of the plurality of second applications.

19. One or more non-transitory computer-readable storage media storing one or more computer programs including computer-executable instructions that, when executed by one or more processors of a first electronic device individually or collectively, cause the first electronic device to perform operations, the operations comprising:
receiving, by the first electronic device, from a second electronic device, first application information associated with a first application executed on the second electronic device;
in response to receiving the first application information, identifying, by the first electronic device, first user interface (UI) information associated with the first application information among stored UI information; and
based on the first UI information, displaying, by the first electronic device, at least one first UI for controlling the first application in a specified spatial area,
wherein the specified spatial area includes a spatial area set by a user within a real environment image obtained in real-time by the first electronic device.

20. The one or more non-transitory computer-readable storage media of claim 19, the operations further comprising:
displaying a first screen associated with the first application based on screen information included in the first application information;
determining whether any one of the at least one first UI has been selected by the user;
based on any one of the at least one first UI being selected by the user, transmitting control information corresponding to the selected UI to the second electronic device;
in response to transmitting the control information, receiving updated screen information from the second electronic device; and
based on receiving the updated screen information, changing the first screen to a second screen corresponding to the updated screen information.
